(19) United States
(12) Patent Application Publication
(10) Pub. No.: US 2021/0330531 A1
(43) Pub. Date: Oct. 28, 2021

(54) SUPPORT STRAPS HAVING FEATURES TO AID IN POSITIONING AND ROTATING A SUBJECT USING AN OVERHEAD LIFT, SYSTEMS AND KITS INCLUDING THE SAME, AND METHODS OF USING THE SAME

(71) Applicant: LIKO RESEARCH & DEVELOPMENT AB, Lulea (SE)

(72) Inventors: Neal Wiggermann, Batesville, IN (US); Michael Buccieri, Greenfield, IN (US); Jacqueline Burris, Indianapolis, IN (US); Alejandro Noe Conejo Castaño, Batesville, IN (US); Morgan Dreyer, Versailles, IN (US); Jie Zhou, Batesville, IN (US)

(73) Assignee: LIKO RESEARCH & DEVELOPMENT AB, Lulea (SE)

(21) Appl. No.: 17/234,098

(22) Filed: Apr. 19, 2021

Related U.S. Application Data
(60) Provisional application No. 63/014,950, filed on Apr. 24, 2020.

(51) Int. Cl. A61G 7/10; A61G 7/00

(52) U.S. Cl. CPC A61G 7/1051; A61G 7/001; A61G 7/1046; A61G 7/1042; A61G 2205/50

(57) ABSTRACT

Support straps having features to aid in positioning and rotating a horizontally laying subject on a support surface, systems including the support straps, and kits of parts including the support straps are described herein. A support strap includes a body having first and second ends spaced a distance apart, at least one first loop extending from the first end, at least one second loop extending from the second end, and indicia on the body, the first loop, and/or the second loop. The indicia indicates an arrangement of the support strap with respect to the subject such that a centerline of the subject is not aligned with a true line of symmetry of the support strap when the first loop is coupled to a first end of a sling bar and the second loop is coupled to a second end of the sling bar.

### CROSS REFERENCE TO RELATED APPLICATION

The present application claims the priority benefit of U.S. Provisional Patent Application Ser. No. 63/014,950, entitled “SUPPORT STRAPS HAVING FEATURES TO AID IN POSITIONING AND ROTATING A SUBJECT USING AN OVERHEAD LIFT, SYSTEMS AND KITS INCLUDING THE SAME, AND METHODS OF USING THE SAME” and filed on Apr. 24, 2020, the entire contents of which is incorporated by reference herein.

### BACKGROUND

### Field

The present specification generally relates to support straps and, more specifically, to support straps having features thereon that aid in positioning the support strap with respect to a subject for the purposes of rotating a subject using an overhead lift.

### Technical Background

Subjects that are supported by a surface for long periods of time can develop injuries such as pressure ulcers or the like if contact between the subject's body and the surface is not periodically adjusted. One means of adjusting contact is rotating the subject from a prone position to a supine position, and vice versa. In addition, rotating the subject from a prone position to a supine position, and vice versa, may be necessary for the purposes of treating various diseases and conditions that affect the respiratory system, including, but not limited to, acute respiratory distress syndrome (ARDS), coronavirus disease (COVID-19), or the like. However, some subjects cannot move themselves between positions because of, for example, unconsciousness of the subject, physical deformity of the subject, size of the subject, and/or the like.

Various apparatuses exist to rotate subjects, but such apparatuses tend to be large, unwieldy, not easily transported, expensive, and not readily available. Certain apparatuses that utilize or incorporate overhead lifts are difficult to operate, require a plurality of different forces to be placed on a subject, require a subject to be oriented in a vertical position between prone and supine states, require medical personnel to manually rotate the subject while the subject is supported by the lift, and/or require a subject to be completely suspended from the lift, which presents potential hazards and increased chances of injury. Further, use of standard lifting aids with an overhead lift such as the Liko® MultiStrap™ lift aid (available from Hillrom of Batesville, Ind.) may not be intuitive for users to determine how exactly to position a subject with respect to the lifting aid and/or how to position the lifting aid on the overhead lift to achieve the correct rotation. As an alternative, medical personnel use various techniques to rotate a subject from a prone position to a supine position, and vice versa, such as, for example, utilizing bed sheets or the like, pushing and pulling on the subject, and/or the like. Such techniques may require a large number of medical personnel, may result in injury or incorrect positioning of the subject, may result in injury to the medical personnel, and/or the like.

### SUMMARY

In a first aspect A1, a support strap includes a body having a first end and a second end. The first end is spaced a distance apart from the second end. The support strap further includes at least one first loop extending from the first end of the body, at least one second loop extending from the second end of the body, and indicia on one or more of the body, the at least one first loop, and the at least one second loop. The indicia indicates an arrangement of the support strap with respect to the subject such that a centerline of the subject is not aligned with a true line of symmetry of the support strap when the at least one first loop is coupled to a first end of a sling bar and the at least one second loop is coupled to a second end of the sling bar. A second aspect A2 includes the first aspect A1, wherein the at least one first loop includes a first long loop and a first short loop, the first long loop being longer in overall length than the first short loop. A third aspect A3 includes the first aspect A1 or the second aspect A2, wherein the at least one second loop includes a second long loop and a second short loop, the second long loop being longer in overall length than the second short loop. A fourth aspect A4 includes the first aspect A1, wherein the at least one first loop includes three or more first loops and the at least one second loop comprises three or more second loops. A fifth aspect A5 includes the first aspect A1, wherein the at least one first loop comprises a first fixed loop and a first detachable loop, the first fixed loop is fixed to the first end of the body and the first detachable loop is removably attached to the first end of the body. A sixth aspect A6 includes the first aspect A1 or the fifth aspect A5, wherein the at least one second loop includes a second fixed loop and a second detachable loop, the second fixed loop is fixed to the second end of the body and the second detachable loop is removably attached to the second end of the body. A seventh aspect A7 includes the first aspect A1, wherein the at least one first loop includes a plurality of entwined loops. An eighth aspect A8 includes the first aspect A1 or the seventh aspect A7, wherein the at least one second loop comprises a plurality of entwined loops. A ninth aspect A9 includes any one of the first-eighth aspects A1-A8, wherein the indicia includes an image or outline of one or more anatomical features to aid in alignment with corresponding anatomical features of the subject. A tenth aspect A10 includes the ninth aspect A9, wherein the one or more anatomical features includes one of more features in a chest area. An eleventh aspect A11 includes the ninth aspect A9, wherein the one or more anatomical features includes one or more features in a hip area. A twelfth aspect A12 includes any one of first-eleventh aspects A1-A11, wherein the indicia includes a centerline marker. A thirteenth aspect A13 includes any one of the first-twelfth aspects A1-A12, wherein the indicia includes one or more edge markers. A fourteenth aspect A14 includes the thirteenth aspect A12, wherein each one of the one or more edge markers are positioned a distance from the first end or the second end of the support strap, the distance representing a particular length of the support strap necessary to cover the subject while the subject is rotating. A fifteenth aspect A15 includes any one of the first-fourteenth aspects A1-A14, wherein the indicia includes an indicator of an upper edge of the support strap is to be longitudinally positioned at a location that is from 1 cm to 15 cm in an inferior direction from a top of a shoulder of the subject. A sixteenth aspect A16 includes any one of the first-fifteenth aspects A1-A15, wherein the indicia includes an indicator of a lower edge of the support strap is to be longitudinally positioned at a location between a waist and a knee of the subject. A seventeenth aspect A17 includes any one of the first-fifteenth aspects A1-A15, wherein the indicia includes an indicator of a lower edge of the support strap is to be longitudinally positioned at a location that corresponds to a greater trochanter of the subject. An eighteenth aspect A18 includes any one of the first-seventeenth aspects A1-A17, wherein the indicia is a color coded indicator that corresponds to a particular one of the of the at least one first loop or a particular one of the at least one second loop to be coupled to the sling bar and a direction of rotation. A nineteenth aspect A19 includes the first aspect A1, wherein the at least one first loop includes a first long loop and a first short loop, the first long loop being longer in overall length than the first short loop, the first long loop having a first color or having stitching of the first color and the first short loop having a second color or having stitching of the second color, and the at least one second loop includes a second long loop and a second short loop, the second long loop being longer in overall length than the second short loop, the second long loop having the second color or having stitching of the second color and the second short loop having the first color or having stitching of the first color. A twentieth aspect A20 includes the nineteenth aspect A19, wherein the indicia includes a first indicator of the first color and a second indicator of the second color, the first indicator indicating that the first long loop and the second short loop are coupled to the sling bar to cause rotation in a first direction, and the second indicator indicating that the first short loop and the second long loop are coupled to the sling bar to cause rotation in a second direction. A twenty-first aspect A21 includes any one of the first-twentieth aspects A1-A20, further including one or more first cut out portions at the first end of the support strap and one or more second cut out portions at the second end of the support strap, the one or more first cut out portions and the one or more second cut out portions reinforced and providing a grasping point for positioning the support strap with respect to the subject. A twenty-second aspect A22 includes any one of the first-twenty-first aspects A1-A21, further including a first major surface constructed of or coated with a high-friction material and a second major surface constructed of or coated with a low-friction material, the low-friction material having a coefficient of friction that is lower than a coefficient of friction of the high-friction material, wherein the support strap is arranged such that the first major surface faces the subject and the second major surface faces the support surface. A twenty-third aspect A23 includes any one of first-twenty-second aspects A1-A22, wherein an edge extending between the first end of the support strap and the second end of the support strap includes one or more side loops coupled to the edge. A twenty-fourth aspect A24 includes any one of the first-twenty-third aspects A1-A23, further including one or more connection points, each one of the one or more connection points couplable to a detachable connector strap. A twenty-fifth aspect A25 includes the twenty-fourth aspect A24, wherein each one of the one or more connection points is a hook and loop connector, a ring connector, a snap connector, or a clip.

In a twenty-sixth aspect A26, a support strap providing features to aid in positioning and rotating a horizontally laying subject on a support surface includes a body having a first end and a second end, the first end spaced a distance apart from the second end. The support strap further includes a first long loop and a first short loop. The first long loop is longer in overall length than the first short loop. The first long loop has a first color or has stitching of the first color and the first short loop has a second color or has stitching of the second color. The support strap further includes a second long loop and a second short loop. The second long loop is longer in overall length than the second short loop. The second long loop has the second color or has stitching of the second color and the second short loop has the first color or has stitching of the first color. The first color is indicative of a first turn direction when the first long loop and the second short loop are coupled to a sling bar, and the second color is indicative of a second turn direction when the first short loop and the second long loop are coupled to the sling bar. A twenty-seventh aspect A27 includes the twenty-sixth aspect A26, wherein one or more of the first long loop, the first short loop, the second long loop, and the second short loop is detachable from the body of the support strap. A twenty-eighth aspect A28 includes the twenty-sixth A26 or twenty-seventh A27 aspect, wherein one or more of the first long loop, the first short loop, the second long loop, and the second short loop is an entwined loop. A twenty-ninth aspect A29 includes any one of the twenty-sixth-twenty-eighth aspects A26-A28, further including a first indicator of the first color and a second indicator of the second color, the first indicator indicating that the first long loop and the second short loop are coupled to the sling bar to cause rotation in a first direction, and the second indicator indicating that the first short loop and the second long loop are coupled to the sling bar to cause rotation in a second direction. A thirtieth aspect A30 includes any one of the twenty-sixth-twenty-ninth aspects A26-A29, further including one or more first cut out portions at the first end of the support strap and one or more second cut out portions at the second end of the support strap, the one or more first cut out portions and the one or more second cut out portions reinforced and providing a grasping point for positioning the support strap with respect to the subject. A thirty-first aspect A31 includes any one of the twenty-sixth-thirtieth aspects A26-A30, further including a first major surface constructed of or coated with a high-friction material and a second major surface constructed of or coated with a low-friction material, the low-friction material having a coefficient of friction that is lower than a coefficient of friction of the high-friction material, wherein the support strap is arranged such that the first major surface faces the subject and the second major surface faces the support surface. A thirty-second aspect A32 includes any one of the twenty-sixth-thirty-first aspects A26-A31, wherein an edge extending between the first end of the support strap and the second end of the support strap includes one or more side loops coupled to the edge. A thirty-third aspect A33 includes any one of the twenty-sixth-thirty-second aspects A26-A32, further including one or more connection points, each one of the one or more connection points couplable to a detachable connector strap. A thirty-fourth aspect A34 includes any one of the twenty-sixth-thirty-third aspects A26-A33, further including indicia indicating an arrangement of the support strap with respect to the subject.

In a thirty-fifth aspect A35, a system for rotating a horizontally laying subject on a support surface includes the support strap of any one of the first-thirty-fourth aspects A1-A34. A thirty-sixth aspect A36 includes the thirty-fifth aspect A35, further including a second strap. A thirty-seventh aspect A37 includes the thirty-sixth aspect A36, further including a connector strap connected to and extending between the support strap and the second strap. A thirty-eighth aspect A38 includes the thirty-seventh aspect A37, wherein the connector strap is sized to correspond to one or more physical dimensions of the subject such that the support strap and the second strap are spaced apart from one another and arranged at predetermined locations with respect to the subject. A thirty-ninth aspect A39 includes any one of the thirty-fifth-thirty-eighth aspects A35-A38, further including an overhead lift supporting the sling bar.

In a fortieth aspect A40, a kit of parts includes the support strap of any one of the first-thirty-fourth aspects A1-A34 and one or more instructions for positioning the support strap with respect to the subject. A forty-first aspect A41 includes the fortieth aspect A40, further including a second support strap and one or more instructions for positioning the second support strap with respect to the subject. A forty-second aspect A42 includes the forty-first aspect A41, further including a connector strap and one or more instructions for positioning the connector strap between the support strap and the second support strap, and for coupling the connector strap to the support strap and the second support strap.

In a forty-third aspect A43, a kit of parts includes a plurality of detachable loops and one or more instructions for coupling one or more first detachable loops of the plurality of detachable loops to a first end of a body of a support strap providing features to aid in positioning and rotating a horizontally laying subject on a support surface, and coupling one or more second detachable loops of the plurality of detachable loops to a second end of the body of the support strap.

In a forty-fourth aspect A44, a method of preparing a horizontally laying subject for rotation includes determining that the subject will be rotated in a first direction, positioning the support strap of any one of the first-thirty-fourth aspects A1-A34 to extend in a lateral direction underneath the subject such that the subject is aligned with the support strap according to the indicia for causing rotation in the first direction, coupling the at least one first loop to the first end of the sling bar, and coupling the at least one second loop to the second end of the sling bar

Additional features and advantages of the aspects described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an illustrative scene of a plurality of individuals performing a rotating method on a subject using an overhead lift and a plurality of support straps according to one or more embodiments shown and described herein;

FIG. 2A schematically depicts an illustrative rail-mounted lift used for rotating a subject according to one or more embodiments shown and described herein;

FIG. 2B schematically depicts an illustrative mobile lift used for rotating a subject according to one or more embodiments described herein;

FIG. 3A schematically depicts an illustrative support strap having indicia thereon for the purposes of arranging a subject thereon according to one or more embodiments shown and described herein;

FIG. 3B schematically depicts another illustrative support strap having a plurality of loops according to one or more embodiments shown and described herein;

FIG. 3C schematically depicts another illustrative support strap having one or more detachable loops according to one or more embodiments shown and described herein;

FIG. 3D schematically depicts another illustrative support strap having entwined loops according to one or more embodiments shown and described herein;

FIG. 3E schematically depicts another illustrative support strap having one or more coded loops and indicia for indicating a turn direction according to one or more embodiments shown and described herein;

FIG. 3F schematically depicts another illustrative support strap having a plurality of cut out portions at each end of the support straps according to one or more embodiments shown and described herein;

FIG. 3G schematically depicts another illustrative support strap having a single cut out portion at each end of the support straps according to one or more embodiments shown and described herein;

FIG. 3H schematically depicts another illustrative support strap having a first major surface with a high-friction material and a second major surface having a low-friction material according to one or more embodiments shown and described herein;

FIG. 3I schematically depicts another illustrative support strap having a plurality of side loops arranged on an upper edge or a lower edge thereof according to one or more embodiments shown and described herein;

FIG. 4A schematically depicts a plurality of illustrative support straps having attachment points thereon for receiving an illustrative detachable connector strap according to one or more embodiments shown and described herein;

FIG. 4B schematically depicts the plurality of support straps with the detachable connector strap connected thereto according to one or more embodiments shown and described herein;

FIG. 5 depicts a flow diagram of an illustrative method of preparing an overhead lift and a plurality of support straps for rotating a subject according to one or more embodiments shown and described herein;

FIG. 6 schematically depicts an illustrative positioning of a subject relative to a plurality of support straps according to one or more embodiments shown and described herein;

FIG. 7A schematically depicts a side view of a plurality of support straps holding a subject and coupled to a sling bar of an overhead lift according to one or more embodiments shown and described herein; and

FIG. 7B schematically depicts a side view of a plurality of support straps holding a subject and coupled to a plurality of sling bars of respective overhead lifts according to one or more embodiments shown and described herein.

### DETAILED DESCRIPTION

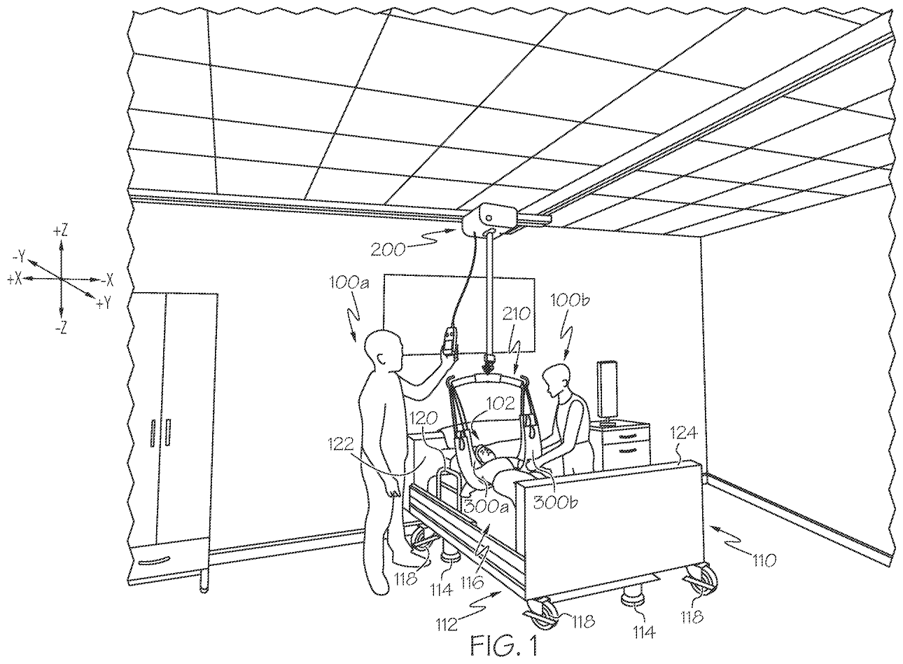

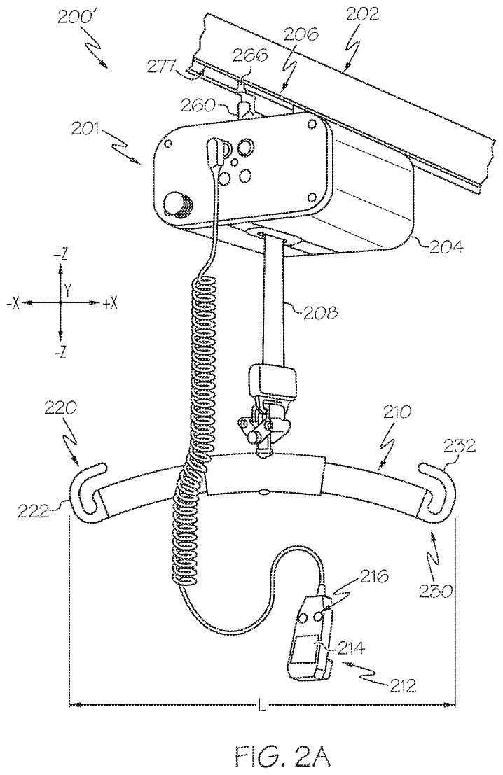

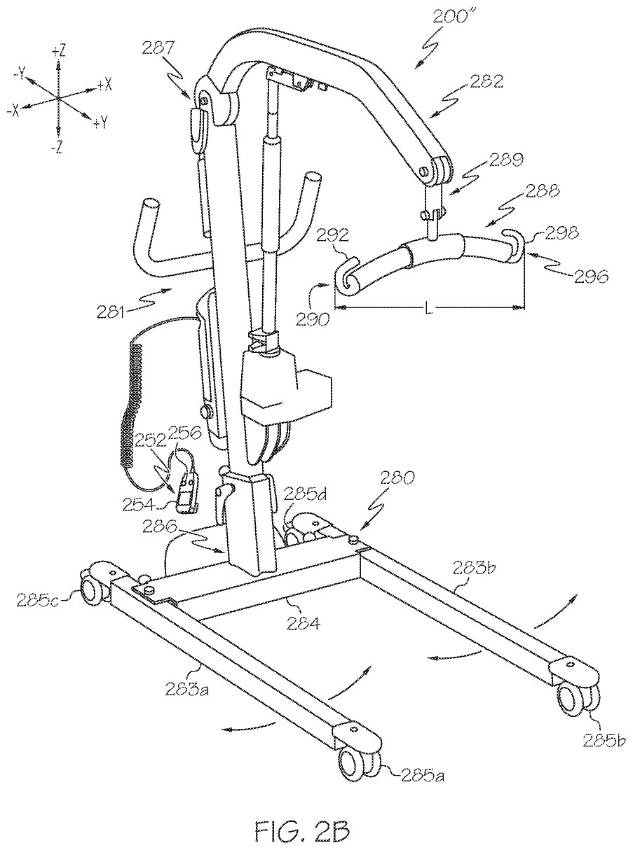

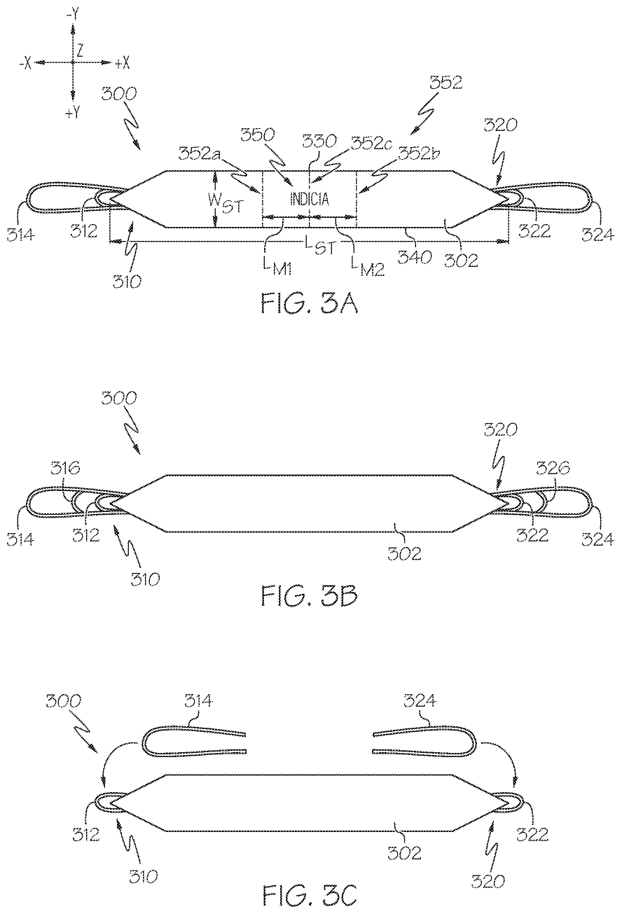

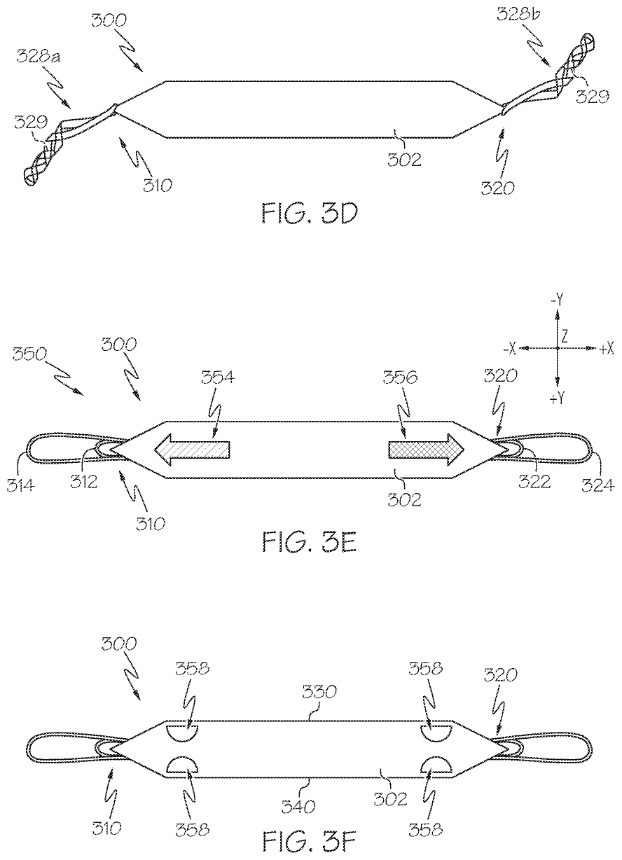

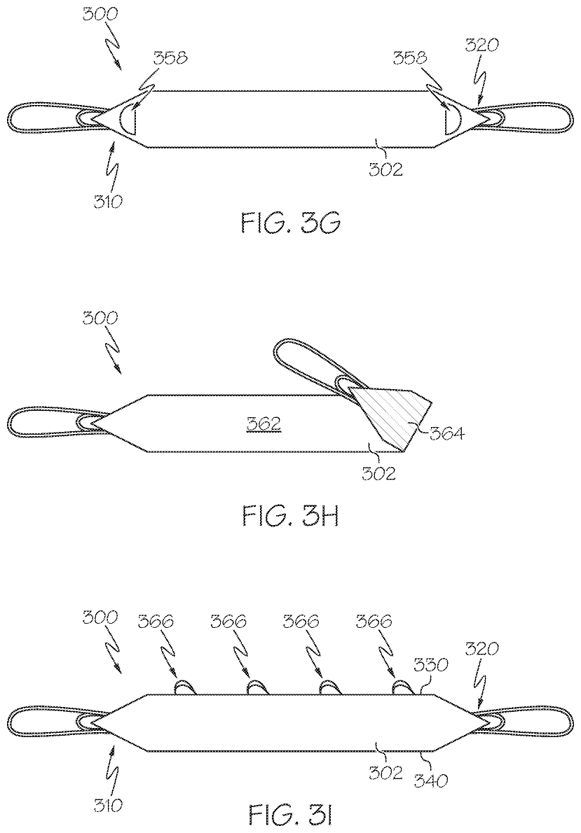

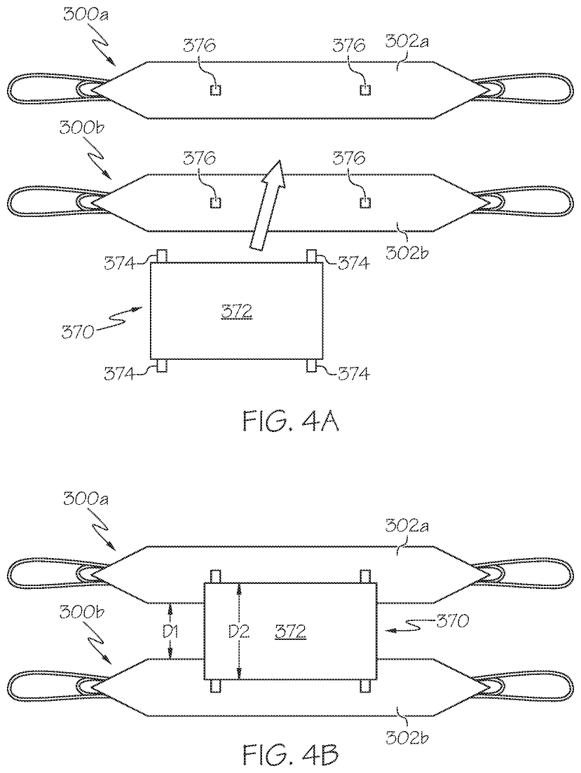

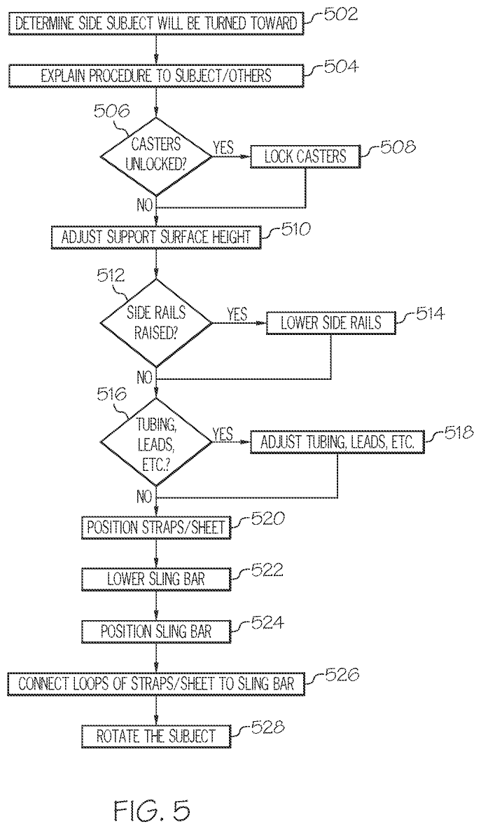

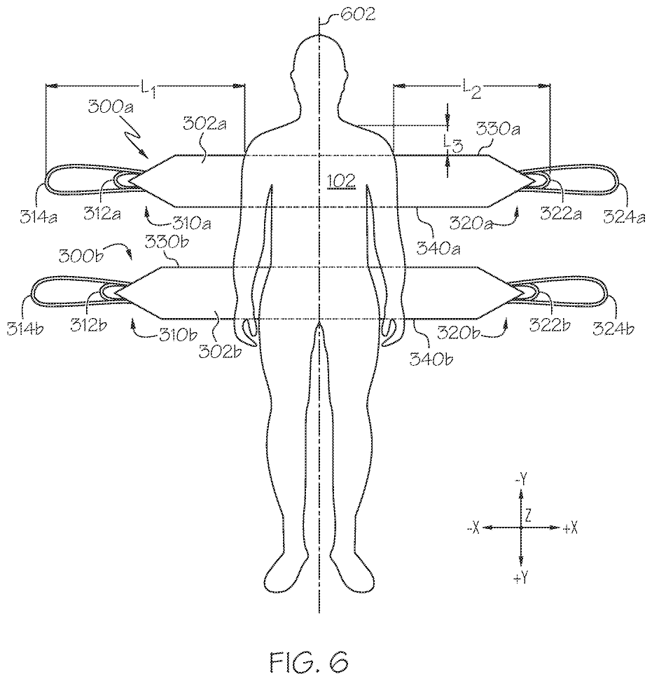

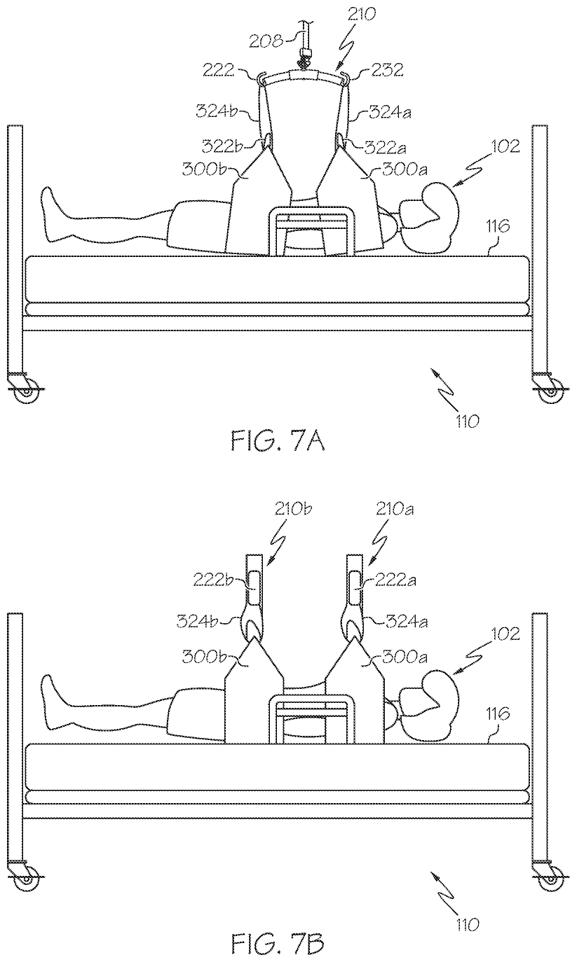

Reference will now be made in detail to various support straps that are customized for the purposes of rotating a subject from a prone position to a supine position and/or from a supine position to a prone position using one or more overhead lifts, examples of which are illustrated in the accompanying drawings. Whenever possible, the same reference numerals will be used throughout the drawings to refer to the same or like parts. One embodiment of a lift system used for carrying out the various methods described herein is depicted in FIG. 1, in which the lift system includes at least one overhead lift and a plurality of support straps. Various overhead lifts for use in the lift system are depicted in FIGS. 2A-2B. FIGS. 3A-3I depict illustrative features of the support straps described herein. FIGS. 4A-4B depict a detachable connector strap that can be coupled to support straps. FIG. 5 depicts various steps in a method of arranging a subject with respect to the support straps and connecting the support straps to one or more overhead lifts, which is schematically depicted in FIGS. 6 and 7A-7B.

As will be evident from the present disclosure, the support straps described herein allow for medical personnel to rotate a horizontally laying subject from a prone position to a supine position (e.g., a 180° rotation) and/or from a supine position to a prone position (e.g., a 180° rotation) with minimum effort relative to previous manual methods of rotating a subject (e.g., personnel pushing and/or pulling on a subject, personnel utilizing bedsheets to move subjects, and/or various other actions that generally require physically demanding actions from medical personnel) and/or previous sling bar-connected straps and sheets. Furthermore, the use of the support straps described herein allows for a rotation process to be completed with fewer personnel relative to other manual methods of rotating a subject. That is, use of support straps described herein can be completed with as few as one or two individuals rotating the subject, whereas other manual methods generally require greater than three individuals, particularly in instances where subjects are large in size (e.g., bariatric subjects), are connected to a plurality of leads, tubing, lines, braces, and/or the like, have a physical deformity that hinders rotational movement, and/or the like. The support straps described herein are connectable to equipment that is more readily available, more easily transported, and less expensive than other devices, systems, and methods that can be used to rotate subjects, such as specialized rotating beds, complex pulley systems that require particular positioning and arrangement over a surface that the subject is laying on, complex pulley systems having drive components for rotating subjects, complex systems that must be bolted to or otherwise connected over a bed or other surface upon which the subject is laying, systems that utilize webbing that may be difficult to arrange with respect to a subject and/or is subject to damage, devices that grip a bedsheet and have a potential to lose such a grip while a rotation process is occurring, and/or the like. The support straps described herein provide features that allow for easier preparation of a subject for rotation, and do not require medical personnel to reconfigure strap loops in the middle of a turning process in order to complete a turn. Moreover, medical personnel do not have to guess or have specialized knowledge in order to appropriately arrange the straps with respect to a subject and/or with respect to a sling bar. Other advantages of the methods described herein will be apparent upon a reading of the present disclosure.

FIG. 1 depicts an illustrative scene of a plurality of individuals (e.g., a first individual 100a and a second individual 100b) performing a method of lifting a subject 102 laying horizontally in a supine position on a person support apparatus 110. As depicted in FIG. 1, the first individual 100a is controlling an overhead lift 200 that includes a sling bar 210 coupled to a plurality of support straps 300 that are positioned underneath the subject 102 (e.g., positioned between the subject 102 and the person support apparatus 110). The second individual 100b is facilitating additional movement of the subject 102 and is ensuring that leads, tubing, lines, braces, and/or the like are correctly positioned, as described in greater detail herein. In some embodiments, an additional individual may also be present, such as a respiratory therapist or the like that maintains a positioning of the head of the subject 102 and ensures appropriate positioning of tubing or the like. As a result of the processes described herein, rotation of the horizontally laying subject 102 is completed to move the subject 180° from supine to prone (or alternatively from prone to supine).

The person support apparatus 110 is generally a support surface for supporting the subject 102 thereon. For example, the person support apparatus 110 may be a hospital bed, a stretcher, a surgical table, a gurney, a chair, or similar support apparatuses commonly found in hospitals, nursing homes, rehabilitation centers, or the like. The person support apparatus 110 generally includes a base frame 112, a plurality of lift members 114 coupled to the base frame 112, and a support surface 116 supported by the base frame 112. The base frame 112 also includes a plurality of wheels or casters 118 that are movable along a ground surface and can be locked in position to prevent or hinder further movement.

The lift members 114 are coupled to various linear actuators, such as jack motors and the like (not shown) and related mechanical and electrical components that facilitate raising, lowering, and tilting the support surface 116 with respect to the base frame 112. Tilting of the support surface 116 relative to the base frame 112 may also be referred to as orienting the support surface 116 in a Trendelenburg orientation or a reverse Trendelenburg orientation. In a Trendelenburg orientation, the head end of the support surface 116 is lower than the foot end of the support surface 116 while in a reverse Trendelenburg orientation, the foot end of the support surface 116 is lower that the head end of the support surface 116.

The person support apparatus 110 may further include side rails 120, a headboard 122, and a footboard 124. The side rails 120, the headboard 122, and the footboard 124 are supported by an upper frame of the person support apparatus 110 that also supports the support surface 116 and is connected to the base frame 112. The side rails 120, the headboard 122, and the footboard 124 are affixed to the upper frame such that the side rails 120, the headboard 122, and the footboard 124 generally define the perimeter edge of the upper frame and the support surface 116 thereon. In some embodiments, the side rails 120 may include a plurality of sections. For example, in some embodiments, the side rails 120 may each include a head side rail portion, located adjacent to the head end of the support surface 116 and an intermediate side rail portion positioned between the head side rail portion and the foot end of the support surface 116. At least one of the side rails 120 may include one or more user interfaces for control and/or display of the features of the person support apparatus 110. Foot pedal controls (not shown) may be coupled to the base frame 112 and communicatively coupled to one or more actuators, motors, or the like for raising and lowering the height of the support surface 116.

The overhead lift 200 is generally a lifting device that is positioned above the subject 102 and the person support apparatus 110 and is movable upwards or downwards (e.g., in the +z/−z direction of the coordinate axes of FIG. 1), as described in greater detail herein. The overhead lift 200, as depicted in FIG. 1, is depicted in greater detail in FIG. 2A as a rail-mounted lift 200′. However, the present disclosure is not limited to the rail-mounted lift 200′ depicted in FIG. 2A. That is, other overhead lifts may be used to perform the methods described herein. One illustrative example of another overhead lift 200 is a mobile lift 200″ depicted in FIG. 2B. The mobile lift 200″ is generally a free standing device that is movable along a floor surface of a hospital or medical facility. The mobile lift 200″ contains one or more components that can be used to lift a person, as described in greater detail herein. While only a single rail-mounted lift 200′ (FIG. 2A) and a single mobile lift 200″ (FIG. 2B) are depicted, it should be understood that a plurality of rail-mounted lifts 200′ (FIG. 2A) or a plurality of mobile lifts 200″ (FIG. 2B) may be used, as described in greater detail herein. Illustrative examples of commercially available lifts that may be used according to the methods described herein include, but are not limited to, a Golvo® lift, a Viking® series lift, a Liko® lift, a LikoGuard™ overhead lift, a Likorall™ overhead lift, a Multirall™ overhead lift, and an UltraTwin™ overhead lift, all available from Hillrom (Batesville, Ind.).

In some embodiments, the mobile lift 200″ (FIG. 2B) may be used in lieu of the rail-mounted lift 200′ (FIG. 2A). That is, either the mobile lift 200″ (FIG. 2B) or the rail-mounted lift 200′ (FIG. 2A) are used to perform the various methods described herein, but not both. For purposes of brevity, the present disclosure outside of FIG. 2B primarily relates to the rail-mounted lift 200′ depicted in FIG. 2A. However, it should be understood that the functionality of the rail-mounted lift 200′ described herein also applies to the mobile lift 200″ of FIG. 2B.

Using the components shown in FIGS. 2A and 2B, the rail-mounted lift 200′ and/or the mobile lift 200″ can be operated via controls within a user interface. For example, as shown in FIG. 2A, the rail-mounted lift 200′ includes a hand control unit 212 that provides user interface functionality. Similarly, as shown in FIG. 2B, the mobile lift 200″ includes a hand control unit 252 that provides user interface functionality. Referring to FIGS. 2A-2B, the hand control unit 212 and the hand control unit 252 provides a user with an ability to complete various tasks including, but not limited to, moving components up/down, moving components laterally, activating the rail-mounted lift 200′ and/or the mobile lift 200″, pairing two rail-mounted lifts 200′ together or pairing two mobile lifts 200″ together, returning the rail-mounted lift 200′ and/or the mobile lift 200″ to a “home” position/location, receiving information from the rail-mounted lift 200′ and/or the mobile lift 200″ (e.g., battery status, weight of load supported by lift unit, movement history, associated subjects, etc.), performing an emergency stop of the rail-mounted lift 200′ and/or the mobile lift 200″, resetting the rail-mounted lift 200′ and/or the mobile lift 200″, and/or the like.

Referring now to FIG. 2A, the rail-mounted lift 200′ generally includes an assembly 201 coupled to a rail 202. More specifically, the assembly 201 includes a lift unit 204 that is slidably coupled to a rail 202 via a carriage 206. The lift unit 204 may be used to support and/or lift a subject with a lifting strap 208 which is coupled to a motor (not shown) contained within the lift unit 204. The motor facilitates extending or retracting the lifting strap 208 from the lift unit 204, thereby raising and lowering a subject attached to the lifting strap 208.

In the embodiment of the rail-mounted lift 200′ depicted in FIG. 2A, a subject may be supported by the lifting strap 208 via a sling bar 210 attached to the lifting strap 208. More specifically, the sling bar 210 may be attached to the plurality of support straps on which the subject is positioned (as described in greater detail hereinbelow), thereby facilitating the lifting operation. The sling bar 210 has a length L extending between a first end 220 of the sling bar 210 and a second end 230 of the sling bar 210. The first end 220 of the sling bar 210 includes a first retention component 222 and the second end 230 of the sling bar 210 includes a second retention component 232. The first retention component 222 and the second retention component 232 are generally shaped, sized, and configured to retain loops of the support straps, as described in greater detail herein. For example, the first retention component 222 and the second retention component 232 may be hook shaped, as depicted in FIG. 2A. The length L of the sling bar 210 is not limited by the present disclosure, and may generally be any length. In some embodiments, the length L of the sling bar 210 may generally correspond to a width of the person support apparatus 110 (FIG. 1). Still referring to FIG. 2A, in other embodiments, the length L of the sling bar 210 may be sufficient to extend a distance that is the same or longer than a lateral width of a subject supported by the sling bar 210 (e.g., a length taken along a transverse plane at a widest location on the subject).

Still referring to FIG. 2A, various components of the assembly 201, such as the lift unit 204 and/or components thereof, may be operated with the hand control unit 212 that is communicatively coupled to the lift unit 204. In the embodiment shown in FIG. 2A, the hand control unit 212 is directly wired to the lift unit 204. However, the hand control unit 212 may be wireless coupled to the lift unit 204 (and/or one or more components thereof) in other embodiments. In some embodiments, the lift unit 204 may be controllable by a remote device wirelessly coupled to the lift unit 204, such as a wall screen, a mobile device, and/or the like.

In some embodiments, the hand control unit 212 may include a display 214 and/or one or more user interface controls 216. The display 214 is generally any liquid crystal display (LCD), light emitting diode (LED) display, electronic ink (e-ink) display, or the like that can display information to a user. In some embodiments, the display 214 may be configured as an interactive display that can receive user inputs (e.g., a touch screen display or the like). The one or more user interface controls 216 may be hardware components that receive inputs from a user and transmit signals corresponding to the inputs, such as a keyboard, a mouse, a joystick, a touch screen, a remote control, a pointing device, a video input device, an audio input device, a haptic feedback device, and/or the like. In some embodiments, the display 214 and one or more of the user interface controls 216 may be combined into a single device, such as a touchscreen display or the like. The display 214 and/or the one or more user interface controls 216 may be used, for example, to allow a user to operate the lift unit 204, such as, for example, to cause the lifting strap 208 to pay out, thereby lowering the sling bar 210 (e.g., move in the −z direction of the coordinate axes of FIG. 2A), to cause the lifting strap 208 to take up, thereby raising the sling bar 210 (e.g., move in the +z direction of the coordinate axes of FIG. 2A).

The lift unit 204 is mechanically coupled to the carriage 206, which facilitates slidably positioning the lift unit 204 along the rail 202. While not depicted in FIG. 2A, the lift unit 204 includes a connection rail which is mounted to a top surface of the lift unit 204. The connection rail facilitates connecting and securing the lift unit 204 to the carriage 206. In embodiments, the carriage 206 generally includes a carriage body 260 having an extension 266 to which a plurality of support wheels (not shown) are rotatably attached for supporting the carriage 206 in the rail 202. The support wheels facilitate positioning the carriage 206 and lift unit 204 along the length of the rail 202. The support wheels are positioned on axles which extend transversely through the carriage body 260.

Still referring to FIG. 2A, the carriage 206 is slidably disposed in the rail 202 for relative movement to the rail 202. Accordingly, it should be understood that, when the lift unit 204 is mechanically coupled to the carriage 206, the lift unit 204 may be traversed along the rail 202 with the carriage 206. The rail 202 is generally formed from a metallic material, such as aluminum, an aluminum alloy, or a similar metallic material. The rail 202 generally includes various walls that form a carriage support channel 277 in which the carriage 206 is slidably disposed. More specifically, the lift unit 204 with attached carriage 206 is suspended from the rail 202 by positioning the extension 266 of the carriage body 260 in the rail 202 such that the support wheels are slidably engaged with support flanges within the carriage support channel 277.

Referring again to FIG. 2B, the mobile lift 200″ may also include a base 280, a lift mast 281 and a lift arm 282. The base 280 may include one or more base legs (e.g., base legs 283a, 283b) which are attached to a cross support 284. The base legs 283a, 283b may include one or more casters (e.g., a pair of front casters 285a, 285b and/or a pair of rear casters 285c, 285d). The rear casters 285c, 285d may comprise caster brakes. In some embodiments, the casters may be powered casters that are coupled to a motor, actuator, or the like that drives movement of the casters, and thus the mobile lift 200″ throughout a space. Control of the motor, actuator, or the like may be completed using the hand control unit 252, as described in greater detail herein.

In one embodiment, the base 280 may further include a mast support 286 disposed on the cross support 184. In one embodiment, the mast support 286 may be a rectangular receptacle configured to receive the lift mast 281 of the mobile lift 200″. For example, a first end of the lift mast 281 may be adjustably received in the mast support 286 and secured with a pin, threaded fastener, or a similar fastener. The pin or threaded fastener may extend through the mast support 286 and into a corresponding adjustment hole(s) (not shown) on the lift mast 281. In another example, the mast support 286 may include an actuator therein that couples to the lift mast and allows for vertical movement of the lift mast 281 (e.g., up and down movement of the lift mast 281 in the +/−z directions of the coordinate axes of FIG. 2B). Accordingly, it will be understood that the position of the lift mast 281 may be adjusted vertically with respect to the base 280 by repositioning the lift mast 281 in the mast support 286 using the actuator. Control of the actuator may be completed using the hand control unit 252, as described in greater detail herein.

In some embodiments, the lift arm 282 is pivotally coupled to the lift mast 281 at a lift arm pivot 287 at a second end of the lift mast 281 such that the lift arm 282 may be pivoted (e.g., raised, lowered, moved from side to side) with respect to the base 280. In some embodiments, the lift arm 282 may be coupled to one or more actuators at the lift arm pivot 287 such that the actuators facilitate the pivot movement of the lift arm 282. Control of the one or more actuators may be completed using the hand control unit 252, as described in greater detail herein.

The lift arm 282 may include at least one sling bar 288 coupled to the lift arm 282 with a coupling member 289 such that the sling bar 288 is raised or lowered with the lift arm 282. In the embodiment shown in FIG. 2B, the coupling member 289 is pivotally attached to the lift arm 282 at an end of the lift arm 282 opposite the lift arm pivot 287. In one embodiment, the coupling member 289 is pivotally attached to the lift arm 282 at attachment pivot such that the sling bar 288 may be pivoted with respect to the lift arm 282. However, it should be understood that, in other embodiments, the coupling member 289 may be fixedly attached to the lift arm 282 or that the sling bar 288 may be directly coupled to the lift arm 282 without the use of a coupling member 289.

A subject may be supported by the lift arm 282 via the sling bar 288 attached to the lift arm 282. More specifically, the sling bar 288 may be attached to the plurality of support straps in which the subject is positioned (as described in greater detail hereinbelow), thereby facilitating the lifting operation. The sling bar 288 has a length L extending between a first end 290 of the sling bar 288 and a second end 296 of the sling bar 288. The first end 290 of the sling bar 288 includes a first retention component 292 and the second end 296 of the sling bar 288 includes a second retention component 298. The first retention component 292 and the second retention component 298 are generally shaped, sized, and configured to retain loops of the support straps, as described in greater detail herein. For example, the first retention component 292 and the second retention component 298 may be hook shaped, as depicted in FIG. 2B. The length L of the sling bar 288 is not limited by the present disclosure, and may generally be any length. In some embodiments, the length L of the sling bar 288 may generally correspond to a width of the person support apparatus 110 (FIG. 1). Still referring to FIG. 2B, in other embodiments, the length L of the sling bar 288 may be sufficient to extend a distance that is the same or longer than a lateral width of a subject supported by the sling bar 288 (e.g., a length taken along a transverse plane at a widest location on the subject).

In the embodiments described herein, the mobile lift 200″ is a mechanized lifting device. Accordingly, raising and lowering the lift arm 282 with respect to the base 280 may be achieved using an actuator such as a lift actuator or the like. The lift actuator may be a linear actuator that includes a motor mechanically coupled to an actuator arm. More specifically, the motor may include a rotating armature and the actuator arm may include one or more threaded rods coupled to the armature such that, when the armature is rotated, the threaded rods are extended or retracted relative to one another and the actuator arm is extended or retracted. In some embodiments, the lift actuator may further include a support tube disposed over the actuator arm. The support tube provides lateral support to the actuator arm as the actuator arm is extended. The lift actuator (as well as any other actuator within the mobile lift 200″) is coupled to an electronic control unit that facilitates actuation and control of the lift actuator. While the embodiments described herein refer to the lift actuator as including a motor and an actuator arm, it will be understood that the lift actuator may have various other configurations and may include a hydraulic or pneumatic actuator comprising a mechanical pump or compressor, or a similar type of actuator. Further, in other embodiments, where the lifting device is a cable-based lift, the lift actuator may be a motor which pays out and/or takes-up cable, thereby raising and/or lowering an attached load. Accordingly, it will be understood that various other types of actuators may be used to facilitate raising and lowering the lift arm 282 and/or an attached load with respect to the base 280.

In some embodiments, the hand control unit 252 may include a display 214 and/or one or more user interface controls 256. The display 254 is generally any liquid crystal display (LCD), light emitting diode (LED) display, electronic ink (e-ink) display, or the like that can display information to a user. In some embodiments, the display 254 may be configured as an interactive display that can receive user inputs (e.g., a touch screen display or the like). The one or more user interface controls 256 may be hardware components that receive inputs from a user and transmit signals corresponding to the inputs, such as a keyboard, a mouse, a joystick, a touch screen, a remote control, a pointing device, a video input device, an audio input device, a haptic feedback device, and/or the like. In some embodiments, the display 254 and one or more of the user interface controls 256 may be combined into a single device, such as a touchscreen display or the like. The display 254 and/or the one or more user interface controls 256 may be used, for example, to allow a user to operate the mobile lift 200″, such as, for example, to cause the lift arm 282 to lower, thereby lowering the sling bar 288 (e.g., move in the −z direction of the coordinate axes of FIG. 2B), to cause the lift arm 282 to raise, thereby raising the sling bar 288 (e.g., move in the +z direction of the coordinate axes of FIG. 2B).

It should be understood that the various embodiments described herein may particularly reference components of the rail-mounted lift 200′ (e.g., sling bar 210). However, it should be understood that the mobile lift 200″ and the components thereof (e.g., sling bar 288) may also be used without departing from the scope of the present disclosure.

FIGS. 3A-3I depict various illustrative features of a support strap 300 (which may also be referred to herein as a “lifting aid”) that may be used for the purposes of rotating a subject as described herein. The features depicted in each of FIGS. 3A-3I may be combined in any manner such that the support strap 300 can be customized with one or more of the features depicted in FIGS. 3A-3I. As such, the features depicted in each of FIGS. 3A-3I are not meant to be limited to certain embodiments that only contain the features depicted in a particular figure. In some embodiments, the various support straps depicted in FIGS. 3A-3I, may each be a modified commercially available support strap, such as the Liko® MultiStrap™ lift aid available from Hillrom (Batesville, Ind.) or may be a wholly new strap not formed from an existing commercially available strap. Referring generally to FIGS. 3A-3I, the support strap 300 is generally a flat strip of material that is positionable under a subject (e.g., subject 102 depicted in FIG. 1).

Referring now to FIG. 3A, the support strap 300 includes a body 302 constructed of a length LST of material, the body 302 having a first end 310 separated from a second end 320 such that the first end 310 is spaced a distance equal to the length LST apart from the second end 320. The length LST of the support strap 300 (e.g., the distance between the first end 310 and the second end 320) is not limited by the present disclosure and may generally be any length, particularly lengths that are suitable for the purposes of rotating a subject according to the methods described herein. For example, the length of the support strap 300 may be less than about 75 cm, about 75 cm long, about 80 cm, about 85 cm, about 90 cm, about 95 cm, about 100 cm, about 105 cm, about 110 cm, about 115 cm, about 120 cm, greater than about 120 cm, or any value or range between any two of these values. In some embodiments, the length LST of the support strap 300 may be such that, when a subject is arranged with respect to the support strap 300 as described herein, the support strap 300 extends a distance laterally from the subject on both sides of the subject. That is, the length LST of the support strap 300 is longer than a lateral width of a subject at a location where the support strap is positioned, as described in greater detail herein. In some embodiments, the length LST of the support strap 300 may be according to a particular type of support strap 300 (e.g., various lengths for small, medium, large, and extra-large sized support straps).

The support strap 300 may further include a first edge 330 (e.g., an upper edge) and a second edge 340 (e.g., a lower edge) spaced apart by a width WST. The width WST of the support strap 300 is not limited by the present disclosure and may generally be any width, particularly widths that are sufficient to be placed underneath the subject 102 (FIG. 1) when the subject 102 is laying on the person support apparatus 110 (FIG. 1). Still referring to FIG. 3A, in some embodiments, the width WST may be according to a particular type of support strap 300 (e.g., various widths for small, medium, large, and extra-large sized support straps). In some embodiments, the width WST of the support strap may be about 10 cm, about 15 cm, about 20 cm, about 25 cm, about 30 cm, about 35 cm, about 40 cm, about 45 cm, about 50 cm, or any value or range between any two of these values (including endpoints). In other embodiments, the width WST of the support strap 300 may be less than about 10 cm and/or greater than about 50 cm.

The general shape of the support strap 300 is not limited by the present disclosure, and may generally be any shape. For example, as depicted in the embodiment of FIGS. 3A-3I, the support strap 300 has a generally rectangular shape with tapered ends. That is, the support strap 300 depicted in the embodiment of FIGS. 3A-3I is shaped such that the first edge 330 and the second edge 340 taper to a point at the first end 310 and the second end 320. In some embodiments, the support strap 300 may be shaped such that the length LST is generally a multiple greater than the width WST thereof. For example, the length LST of the support strap 300 may be about three times or more greater than the width WST of the support strap 300. In some embodiments, such a multiple may provide dimensions that aids in ease of placement of the support strap 300 underneath a subject. Certain other shapes that allow for ease of use in placing the support strap 300 underneath a subject are also contemplated, such as strips of material that have a length that is greater than a width thereof.

Still referring to FIG. 3A, the support strap 300 may generally be constructed of any type of material, and such materials are not limited by the present disclosure. In some embodiments, the support strap 300 may be constructed of a material that has load bearing properties allowing the support strap 300 to support the weight of a human subject. In some embodiments, the support strap 300 may be formed from a textile comprising natural fibers that are derived from animal (protein), vegetable (cellulose), and/or mineral sources. Illustrative examples of natural fibers include, but are not limited to, cellulose (staple) fibers such as bast, leaf, seed hair, cane, grass, and reed; protein (staple) fibers such as hair, wool, and/or filaments (e.g., secretions such as silk); and mineral fibers such as asbestos, glass, gold, silver, and/or the like. In some embodiments, the straps 210, 220, 230 may be formed from one or more manufactured fibers such as manmade (humanmade), regenerated, or synthetic fibers having a chemical composition that is organic or inorganic or derivatives thereof. In some embodiments the straps 210, 220, 230 may be formed from one or more fibers having a chemical composition that is organic or inorganic. Illustrative examples of organic polymer fibers from natural sources include, but are not limited to, acetate, alginate, cupro, elastodiene, lyocell, model, triacetate, and viscose. Illustrative examples of organic fibers made from synthetic polymers include, but are not limited to, acrylic, aramid, chlorofibre, elastane, elastodiene, elastoelfin, elastomultiester, flurofiber, melamine, modacrylic, polyamide, polyester, polyethelene, polyimide, polylactic acid, polypropylene, polypropylene/polyamide biocomponent, and vinylal. Illustrative examples of inorganic fibers include, but are not limited to, carbon, ceramic, glass, and metal. Other materials that may be used for the support strap are discussed hereinbelow with respect to FIG. 3H.

In various embodiments, the support strap 300 generally includes at least one first loop extending from the first end 310 of the body 302 and at least one second loop extending from the second end 320 of the body 302. For example, as depicted in FIG. 3A, the support strap 300 includes a first short loop 312 and a first long loop 314 coupled at the first end 310 of the support strap 300 and a second short loop 322 and a second long loop 324 coupled at the second end 320 of the support strap 300. The loops each provide a connection point for the support strap 300 to be connected to another object. For example, in the embodiments described herein, the loops are used as a connection point for connecting the support strap 300 to the sling bar 210 (FIG. 1). The loops (e.g., the first short loop 312, the first long loop 314, the second short loop 322, and the second long loop 324) are coupled to the body 302 of the support strap 300 by any means of coupling, including, but not limited to, stitching, welding, use of fasteners (e.g., rivets or the like), use of adhesives, and/or the like. In some embodiments, the loops are integrated with the body 302 of the support strap 300. That is, the loops are formed as an extension of the material of the support strap 300 such that the support strap 300 (including the loops) are all formed from a single piece of material. In some embodiments, the loops may be formed as an extension of a piping material that surrounds the various edges of the body 302 of the support strap 300. As depicted in FIG. 3A, the first short loop 312 and the first long loop 314 are coupled to the tapered portion of the body 302 of the support strap 300 at the first end 310 thereof. Similarly, the second short loop 322 and the second long loop 324 are coupled to the tapered portion of the body 302 of the support strap 300 at the second end 320 thereof.

Each of the loops (e.g., the first short loop 312, the first long loop 314, the second short loop 322, and the second long loop 324) may have an overall length that is defined by a distance between a first connection point with the material of the support strap 300 and a second connection point with the material of the support strap 300. The first long loop 314 is generally longer in overall length than the first short loop 312 and the second long loop 324 is generally longer in overall length than the second short loop 322. The varying lengths of the loops provides an adjustable total usable length of the support strap 300, depending on which loop is connected. For example, if the support strap 300 is connected via the first short loop 312 and the second short loop 322, the total usable length of the support strap 300 is less than a total usable length of the support strap 300 when connected via the first long loop 314 and the second long loop 324. In some embodiments, the first short loop 312 and the second short loop 322 may have substantially similar lengths while the first long loop 314 and the second long loop 324 have substantially similar lengths. In other embodiments, the various loops may have different lengths. The lengths of the loops are otherwise not limited by the present disclosure, and may be any length. Illustrative lengths of the first short loop 312 and the second short loop 322 may be about 5 cm, about 10 cm, about 15 cm, about 20 cm, about 25 cm, about 30 cm, about 35 cm, about 40 cm, about 45 cm, about 50 cm, or any value or range between any two of these values (including endpoints). Illustrative lengths of the first long loop 314 and the second long loop 324 may be about 20 cm, about 25 cm, about 30 cm, about 35 cm, about 40 cm, about 45 cm, about 50 cm, about 55 cm, about 60 cm, about 65 cm, about 70 cm, about 75 cm, about 80 cm, about 85 cm, about 90 cm, about 95 cm, about 100 cm, or any value or range between any two of these values (including endpoints).

The loops (e.g., the first short loop 312, the first long loop 314, the second short loop 322, and the second long loop 324) may generally be constructed of any type of material, and such materials are not limited by the present disclosure. In some embodiments, the loops may be constructed of a material that has load bearing properties that allow the support strap 300, together with the loops, to support the weight of a human subject. In some embodiments, the loops may be formed from a textile comprising natural fibers that are derived from animal (protein), vegetable (cellulose), and/or mineral sources. Illustrative examples of natural fibers include, but are not limited to, cellulose (staple) fibers such as bast, leaf, seed hair, cane, grass, and reed; protein (staple) fibers such as hair, wool, and/or filaments (e.g., secretions such as silk); and mineral fibers such as asbestos, glass, gold, silver, and/or the like. In some embodiments, the straps 210, 220, 230 may be formed from one or more manufactured fibers such as manmade (humanmade), regenerated, or synthetic fibers having a chemical composition that is organic or inorganic or derivatives thereof. In some embodiments the straps 210, 220, 230 may be formed from one or more fibers having a chemical composition that is organic or inorganic. Illustrative examples of organic polymer fibers from natural sources include, but are not limited to, acetate, alginate, cupro, elastodiene, lyocell, model, triacetate, and viscose. Illustrative examples of organic fibers made from synthetic polymers include, but are not limited to, acrylic, aramid, chlorofibre, elastane, elastodiene, elastoelfin, elastomultiester, flurofiber, melamine, modacrylic, polyamide, polyester, polyethelene, polyimide, polylactic acid, polypropylene, polypropylene/polyamide biocomponent, and vinylal. Illustrative examples of inorganic fibers include, but are not limited to, carbon, ceramic, glass, and metal. In some embodiments, the loops may be formed of the same material as the material used for the remainder of the support strap 300. In other embodiments, the loops may be formed from a different material than the material used for the remainder of the support strap 300. In some embodiments, the material used to form the loops (e.g., the first short loop 312, the first long loop 314, the second short loop 322, and the second long loop 324) may be colored such that various loops have different coloring, thereby providing indicia to aid a user in determining which loops to couple to the sling bar 210 (FIG. 1). Still referring to FIG. 3A, in some embodiments, stitching that is used to attach the various loops to the body 302 of the support strap 300 and/or portions of the loops together (or to themselves) may be colored such that various loops or portions thereof have different coloring, thereby providing indicia to aid a user in determining which loops to couple to the sling bar 210 (FIG. 1). Further detail regarding coloring of the loops and/or the stitching is described in further detail herein with respect to FIGS. 3D and 3E.

It should be understood that the loops depicted in FIG. 3A (e.g., the first short loop 312, the first long loop 314, the second short loop 322, and the second long loop 324) are merely one illustrative embodiment. In some embodiments, such as the embodiment depicted in FIG. 3B, a greater number of loops may be included, such as, for example, a first additional loop 316 and a second additional loop 326. The first additional loop 316, like the first short loop 312 and the first long loop 314, is coupled to or integrated with the tapered portion of the body 302 of the support strap 300 at the first end 310 thereof. Similarly, the second additional loop 326, like the second short loop 322 and the second long loop 324, is coupled to or integrated with the tapered portion of the body 302 of the support strap 300 at the second end 320 thereof. The first additional loop 316 and the second additional loop 326 may generally be constructed of the same material as the various other loops (e.g., the first short loop 312, the first long loop 314, the second short loop 322, and the second long loop 324), including colored material and/or stitching as described herein. As depicted in FIG. 3B, the first additional loop 316 and the second additional loop 326 are a length that is generally between the lengths of the other respective loops. That is, the first additional loop 316 is generally longer than the first short loop 312 and shorter than the first long loop 314 and the second additional loop 326 is generally longer than the second short loop 322 and shorter than the second long loop 324. However, the first additional loop 316 and the second additional loop 326 may generally be any length without departing from the scope of the present disclosure. In some embodiments, the first additional loop 316 and the second additional loop 326 may be coupled to the first long loop 314 and the second long loop 316, respectively, instead of to the material of the support strap 300. While FIG. 3B depicts three loops on each side of the support strap 300 (e.g., the first short loop 312, the first long loop 314, the first additional loop 316, the second short loop 322, the second long loop 324, and the second additional loop 326), the present disclosure is not limited to such. Greater than three loops on each side of the support strap 300 may also be used, which may provide greater flexibility in adjusting an overall length of the support strap 300 (including the length of the loops) when coupled to the sling bar 210 (FIG. 1) and greater flexibility in adjusting the relative positioning of the support strap 300 with the subject 102 (FIG. 1) when coupled to the sling bar 210.

In some embodiments, one or more of the loops may be removably attached to the body 302 of the support strap 300. For example, as depicted the embodiment of FIG. 3C, the first long loop 314 and the second long loop 324, respectively, may be removably attached (e.g., detachable) to the body 302 of the support strap 300. That is, the first short loop 312 and the second short loop 322 are coupled to or integrated with the tapered portion of the body 302 of the support strap 300, respectively, at the first end 310 and the second end 320 thereof such that the first short loop 312 and the second short loop 322 are generally not removed from the body 302 of the support strap 300 (e.g., fixed loops) whereas the first long loop 314 and the second long loop 334 are coupled via fasteners (e.g., snaps, clips, hook and loop connectors, or the like) or are tied (e.g., via knots or the like) such that the first long loop 314 and the second long loop 324 can be removed from the body 302 of the support strap 300 (e.g., when not in use). While the embodiment of FIG. 3C depicts the first long loop 314 and the second long loop 312 as being removable or detachable, the present disclosure is not limited to such. For example, various other loops (including loops not depicted in FIG. 3C) may be removably attached (e.g., detachable) to the body 302 of the support strap 300 in other embodiments, such as the first short loop 312, the second short loop 322, and/or the like.

In some embodiments, various loops coupled to the body 302 of the support strap 300 may be entwined loops. For example, as depicted in FIG. 3D, a plurality of first entwined loops 328a are coupled to the first end 310 of the body 302 of the support strap 300 and a plurality of second entwined loops 328b are coupled to the second end 320 of the body 302 of the support strap 300. Each of the plurality of first entwined loops 328a and the plurality of second entwined loops 328b is constructed of a single piece of loop material that extends, respectively, from each of the first end 310 and the second end 320. The single piece of loop material includes a plurality of loops that are formed at particular distances along the length of the single piece of loop material by twisting, crossing over, and/or securing (e.g., coupling via stitching 329, bonding, welding, gluing, or the like) the single piece of loop material one or more times to form the various entwined loops. In some embodiments, the stitching 329 that secures portions of the plurality of first entwined loops 328a and the plurality of second entwined loops 328b may be a material that is different in color from the material used for the plurality of first entwined loops 328a and the plurality of second entwined loops 328b so as to provide various indicators, as described further herein. In some embodiments, the stitching 329 may be a particular color in a first location, a particular color in a second location, or the like, so as to signify a particular opening to be used in a particular scenario, as described further herein. While the term “entwined loops” is used herein, other similar terms are contemplated, including, but not limited to, webbing, woven loops or braided loops.

While the embodiment of FIG. 3D depicts the each of the plurality of first entwined loops 328a and the plurality of second entwined loops 328b having a total of four openings, the present disclosure is not limited to such. Other embodiments including fewer or greater than four openings are contemplated. Each one of the openings formed from the plurality of first entwined loops 328a and the plurality of second entwined loops 328b is shaped, sized and configured to be placed over connection points of a sling bar, as described in greater detail herein. In some embodiments, each of the openings of each one of the plurality of first entwined loops 328a and the plurality of second entwined loops 328b may be positioned a particular distance away from the body 302 of the support strap 300. The varying distances of the openings from the body 302 of the support strap 300 provides an adjustable total usable length of the support strap 300, depending on which opening is connected.

Referring again to FIG. 3A, in some embodiments, the support strap 300 may have indicia 350 thereon. The location and type of indicia 350 is not limited by the present disclosure, and may generally be any location and type. The various embodiments discussed herein with respect to FIGS. 3A, 3D, and 3E provide illustrative examples of indicia that may be present on the support strap 300. Still referring to FIG. 3A, the indicia 350 may be located, for example, on one or more of the body 302, the first short strap 312, the first long strap 314, the second short strap 322, and the second long loop 324. The indicia 350 generally provides an indication of an arrangement of the support strap 300 with respect to a subject. That is, the indicia 350 provides one or more indicators to a user about how to position the subject with respect to the support strap 300 to ensure the subject is appropriately rotated when lifted. For example, the indicia 350 may indicate an arrangement of the support strap 300 with respect to the subject such that a centerline of the subject is not aligned with a true line of symmetry of the support strap 300 when the loops are connected to the sling bar 210 (FIG. 1). For example, still referring to FIG. 3A, the true line of symmetry of the support strap when the first short loop 312 and the second short loop 322 are connected to the sling bar 210 (FIG. 1) or when the first long loop 314 and the second long loop 324 are connected to the sling bar 210 (FIG. 1) is in the center of the support strap 300 in embodiments where the first short loop 312 and the second short loop 322 are the same length and the first long loop 314 and the second long loop 324 are the same length. In another example where the first short loop 312 and the second short loop 322 are the same length and the first long loop 314 and the second long loop 324 are the same length, coupling the first short loop 312 and the second long loop 324 to the sling bar 210 (FIG. 1) results in a true line of symmetry that is to the right of the center of the support strap 300 (e.g., in the +x direction of the coordinate axes of FIG. 3A from the center of the support strap 300). In yet another example where the first short loop 312 and the second short loop 322 are the same length and the first long loop 314 and the second long loop 324 are the same length, coupling the first long loop 314 and the second short loop 322 to the sling bar 210 (FIG. 1) results in a true line of symmetry that is to the left of the center of the support strap 300 (e.g., in the −x direction of the coordinate axes of FIG. 3A from the center of the support strap 300). As such, in embodiments where the first short loop 312 and the second short loop 322 are the same length and the first long loop 314 and the second long loop 324 are the same length and a turning process includes coupling of the first long loop 314 and the second short loop 322 to the sling bar 210 (FIG. 1) or coupling of coupling the first short loop 312 and the second long loop 324 to the sling bar 210 (FIG. 1), which results in a true line of symmetry that is off center from the center of the support strap 300, the indicia 350 may be placed such that a centerline of the subject is aligned with the center of the support strap 300 so that the subject is not aligned with the true line of symmetry of the support strap 300. Such indicia 350 is depicted in FIG. 3A as a first edge marker 352a, a second edge marker 352b, and/or a centerline marker 352c (collectively, markers 352). The first edge marker 352a and the second edge marker 352b are generally spaced a distance apart from the centerline marker 352c and represent outer bounds of where a subject should be located when positioned with respect to the support strap 300. That is, the first edge marker 352a and the second edge marker 352b are located such that a subject can be placed over the support strap 300 between the edge markers and the first edge marker 352a and the second edge marker 352b are still visible on either side of the subject. For example, the first edge marker 352a may be placed a first marker length L_{M1} from the centerline marker 352c and the second edge marker 352b may be placed a second marker length L_{M2} from the centerline marker 352c. In some embodiments, the first marker length L_{M1} and the second marker length L_{M2} may be substantially equal to one another. In other embodiments, the first marker length L_{M1} may be different (e.g., shorter or longer) than the second marker length L_{M1}. In some embodiments, the first marker length L_{M1} may be about 30 centimeters (cm). In some embodiments, the second marker length L_{M2} may be about 30 cm. However, it should be understood that the marker lengths are merely illustrative and may be greater than or less than 30 cm in other embodiments. In some embodiments, the first marker length L_{M1} of the first edge marker 352a and the second marker length L_{M2} of the second edge marker 352b may be such that a distance between the first edge marker 352a and the first end 310 and/or a distance between the second edge marker 352b and the second end 320 allows for sufficient length of the support strap 300 necessary to cover a subject positioned on the support strap 300 while the subject is rotating. That is, the first edge marker 352a and the second edge marker 352b are not placed so close to the first end 310 and the second end 320 that the respective loops cannot be coupled to the sling bar because of an insufficient length of material available for a connection due to a location of the subject with respect to the support strap 300. In some embodiments, the first marker length L_{M1} of the first edge marker 352a and the second marker length L_{M2} of the second edge marker 352b may be customized such that certain support straps 300 have particular lengths to correspond to particular patient sizes (e.g., particular lengths for small, medium, large, extra-large, or the like sized straps). In some embodiments, a plurality of first edge markers 352a and a plurality of edge markers 352b may be provided at varying distances from the centerline marker 352c, where each pair of first edge markers 352a and second edge markers 352b corresponds to a particular subject size. For example, a first pair of edge markers may be spaced closer together relative to other pairs (e.g., such that L_{M1}+L_{M2} is smaller relative to other pairs), which may be used for relatively smaller subjects (e.g., a size small pair), a second pair of edge markers may be spaced further apart relative to other pairs (e.g., such that L_{M1}+L_{M2} is larger relative to other pairs), which may be used for relatively larger subjects (e.g., a size large pair), and a third pair of edge markers may be spaced between the first pair and the second pair (e.g., such that L_{M1}+L_{M2} of the third pair is between the other pairs), which may be used for medium sized subjects (e.g., a size medium pair). In some embodiments, the various pairs may be indicated by size with other indicia 350 such that a user can determine which pair to use for a particular subject. In some embodiments, the various pairs may be color coded or otherwise visually distinguishable from one another such that a user can determine which two of the edge markers are a pair. In some embodiments, the various pairs may be color coded to correspond to a color of a particular pair of loops, a colored stitching on a particular pair of loops, a particular stitching pattern on a particular pair of loops and/or the like such that a user may visually determine which pair(s) of loops to use for a particular pair of edge markers, and also which pair(s) of loops to use for a particularly sized subject.

While the embodiment of FIG. 3A depicts the first edge marker 352a, the second edge marker 352b, and the centerline marker 352c as being dashed lines that run from the first edge 330 to the second edge 340, the present disclosure is not limited to such. That is, the first edge marker 352a, the second edge marker 352b, and the centerline marker 352c may each be any other type of line, shape, image, or the like that provides an indicator as described herein. For example, the first edge marker 352a, the second edge marker 352b, and the centerline marker 352c could be formed in the approximate shape of a portion of a human torso. Still further, the indicia 350 depicted in FIG. 3A as the first edge marker 352a, the second edge marker 352b, and the centerline marker 352c and text is also merely one illustrative example. That is, the indicia 350 may be other objects, images, renderings, drawings, or the like. For example, the indicia 350 may be an image or an outline of one or more anatomical features to aid in alignment with corresponding anatomical features of a subject. That is, in embodiments where the support strap 300 is to be arranged at a chest area of a subject, the indicia 350 may be a partial torso outline of a chest (e.g., one or more features of a chest area), a drawing of ribs, arms, and/or the like. In embodiments where the support strap 300 is to be arranged at or near a greater trochanter of a subject, the indicia 350 may be a partial outline of a hip area, a drawing of hip bones, a drawing of leg bones, and/or the like. In another example, the indicia 350 may provide an indication that the first edge 330 of the body 302 of the support strap 300 is to be particularly placed with respect to the subject. That is, the indicia 350 may include one or more arrows, text, anatomical drawings, measurement marks (e.g., a ruler), or the like that indicates that the first edge 330 of the body 302 of the support strap 300 is to be longitudinally positioned at a location that is from about 1 cm to about 15 cm in an inferior direction from a top of a shoulder of a subject. In yet another example, the indicia 350 may provide an indication that the second edge 340 of the body 302 of the support strap 300 is to be particularly placed with respect to the subject. That is, the indicia 350 may include one or more arrows, text, anatomical drawings, measurement marks (e.g., a ruler), or the like that indicates that the second edge 340 of the body 302 of the support strap 300 is to be longitudinally positioned at a location that is between a waist and a knee of a subject and/or in an area that corresponds to a greater trochanter of the subject.

Referring now to FIG. 3E, another illustrative example of the indicia 350 is depicted. The embodiment of FIG. 3E generally includes indicia 350 that is a color coded indicator that corresponds to one or more of the loops that are coupled to the sling bar 210 (FIG. 1) to provide a particular direction of rotation. More specifically, as depicted in FIG. 3E, the indicia 350 includes the first long loop 314, the second short loop 322, and a first directional indicator 354 (e.g., an arrow) all having a first color and/or a stitching with the first color. In addition, the indicia 350 includes the first short loop 312, the second long loop 324, and a second directional indicator 356 (e.g., an arrow) all having a second color and/or a stitching with the second color, where the second color is visually different from the first color such that an individual viewing the support strap 300 can easily discern between the first color and the second color. For example, the first long loop 314, the second short loop 322, and the first directional indicator 354 may be colored black (and/or may have black stitching) and the first short loop 312, the second long loop 324, and the second directional indicator 356 may be colored white (and/or may have white stitching) in some embodiments. The coloring may be a particular material color, dyed material, material that has a colored coating (e.g., paint or the like), material that has the color printed thereon, and/or the like. For example, the loops may be colored by using a dyed material of a particular color and the directional indicators 354, 356 may be printed on the body 302 of the support strap 300.

The first directional indicator 354 and the second directional indicator 356 generally provide an indication of a direction in which the subject will turn if the corresponding loops are connected to the sling bar 210 (FIG. 1) and the sling bar 210 is raised by the overhead lift 200 (e.g., a turn direction). For example, still referring to FIG. 3E, the first directional indicator 354 and the second directional indicator 356 may each be an arrow that is placed (e.g., printed, sewn, or the like) on the body 302 of the support strap 300, the arrow pointing in the turn direction. That is, the first directional indicator 354 points toward the first end 310, thereby indicating that the subject, when appropriately placed with respect to the support strap 300 and when the first long loop 314 and the second short loop 322 are coupled to the sling bar 210 (FIG. 1), will turn toward the first end 310 (e.g., in the −x direction of the coordinate axes depicted in FIG. 3E). In addition, the second directional indicator 356 points toward the second end 320, thereby indicating that the subject, when appropriately placed with respect to the support strap 300 and when the first short loop 312 and the second long loop 324 are coupled to the sling bar 210 (FIG. 1), will turn toward the second end 320 (e.g., in the +x direction of the coordinate axes depicted in FIG. 3E). It should be understood that the first directional indicator 354 and the second directional indicator 356 are merely illustrative, and any other indicia that indicate to a user which of the loops to connect to the sling bar 210 (FIG. 1) and the direction of rotation are included within the scope of the present disclosure.

FIGS. 3F and 3G depict two illustrative embodiments of various grip points that may be located on the support strap 300 to aid users in holding onto the support strap 300 when arranging the support strap 300 with respect to the subject. More specifically, FIG. 3F depicts two cut out portions 358 located at each of the first end 310 and the second end 320 of the body 302 of the support strap 300 and FIG. 3G depicts a single cut out portion 358 located at each of the first end 310 and the second end 320 of the body 302 of the support strap 300. The cut out portions 358 are generally holes in the material of the body 302 that allow objects (e.g., fingers or the like) to pass therethrough. FIG. 3F generally depicts the cut out portions 358 as being aligned with the first edge 330 and the second edge 340 of the body 302 of the support strap 300 such that a user could, for example, grasp the edges 330, 340 at either end 310, 320 of the body 302 and wrap his or her fingers through the cut out portions 358 to establish a grip on the support strap 300. FIG. 3G generally depicts the cut out portions 358 as being in or near the tapered portions of the body 302 at the first end 310 and the second end 320 such that a user could, for example, grasp the area of the tapered portion and wrap his or her fingers through a cut out portion 358 to establish a grip on the support strap 300. In some embodiments, the cut out portions 358 may be reinforced such that they are able to withstand the forces applied to the body 302 of the support strap 300 during movement. Other numbers and locations of cut out portions are contemplated and included within the scope of the present disclosure. While FIGS. 3F and 3G depict the cut out portions 358 being generally semicircular, other shapes of cut out portions 358 are contemplated and included within the scope of the present application. In addition, the size of the cut out portions 358 is not limited in the present disclosure, and the cut out portions 358 may be any size.

FIG. 3H depicts another feature that may aid users in arranging the support strap 300 with respect to the subject. More specifically, FIG. 3H depicts the body 302 of the support strap 300 having a first major surface 362 and a second major surface 364. The body 302 may be constructed such that the first major surface 362 is constructed of or coated with a high-friction material and the second major surface 364 is constructed of or coated with a low-friction material. The low-friction material is generally any material having a coefficient of friction that is lower than a coefficient of friction of the high-friction material. In some embodiments, the low-friction material may be any material that has a coefficient of friction that is lower than a coefficient of friction of an uncoated or untreated surface of the body 302. In some embodiments, the high-friction material may be any material that has a coefficient of friction that is the same or higher than a coefficient of friction of an uncoated or untreated surface of the body 302. The coefficient of friction is a quantitative measure of the friction between two surfaces, including the first major surface 362 and the second major surface 364, including surface roughness, and environmental conditions such as, but not limited to, temperature and humidity. In some embodiments, the coefficient of friction refers to a maximum coefficient of friction measured at a normal load of 30 N as measured in a standard test equipment, such as, for example, a vial overlay test jig. In one example, a low coefficient of friction may be about 0.9 or less relative to an uncoated surface, including, about 0.9, about 0.8, about 0.7, about 0.6, about 0.5, about 0.4, about 0.3, about 0.2, about 0.1 or less relative to an uncoated surface, or any range or value between any two of these values. In another example, a high coefficient of friction may be about 1.0 or greater relative to an uncoated surface, including about 1.0, about 1.5, about 2.0, about 2.5, about 3.0, about 3.5, about 4.0 or greater relative to an uncoated surface, or any range or value between any two of these values. In some embodiments, the second major surface 364 having the low-friction material may be constructed such that a low-friction coating on the second major surface 364 is directional. That is, for example, the second major surface 364 may exhibit a lower coefficient of friction along a length of the support strap 300 relative to a coefficient of friction along a width of the support strap 300.

In some embodiments, the support strap 300 may be arranged relative to the subject such that the first major surface 362 having the high-friction material faces the subject and the second major surface 364 having the low-friction material faces the surface upon which the subject is laying. Such an arrangement may allow the support strap to be more easily slid underneath the subject (e.g., such that the low-friction surface slides more easily along the support surface) relative to a surface not having the low friction material thereon or integrated therewith. Further, the high-friction material may retain a grip on the subject to avoid slippage, particularly when the subject is lifted for the purposes of turning.

FIG. 3I depicts a further feature that may aid users in arranging the support strap 300 with respect to the subject. More specifically, FIG. 3I depicts the first edge 330 of the body 302 of the support strap 300 having a plurality of side loops 366 arranged thereon. Each one of the plurality of side loops 366 may be similar in design and construction as the various loops described herein (e.g., the first short loop 312, the first long loop 314, the second short loop 322, and the second long loop 324 described herein with respect to FIG. 3A), and thus are not further described for the purposes of brevity. The plurality of side loops 366 can be gripped by a user and used as an additional grip point for moving the support strap 300 relative to a subject. While FIG. 3I depicts four side loops 366, the present disclosure is not limited to such, and a greater or fewer number of side loops 366 are contemplated, including one or more side loops 366. In addition, while FIG. 3I depicts each of the plurality of side loops 366 being disposed approximately equidistant from one another between the first end 310 and the second end 320 of the body 302, the present disclosure is not limited to such, and different spacing is contemplated. Further, while FIG. 3I depicts each of the plurality of side loops 366 being located only on the first edge 330 of the body 302, the present disclosure is not limited to such, and one or more of the plurality of side loops 366 being located on the second edge 340 or other locations of the body 302 are contemplated.

In various embodiments, a plurality of support straps may be used to support a subject when rotating the subject. As noted herein, placement of the various support straps may be at particular points relative to the subject to ensure a correct rotation. As such, in some embodiments, a component may be used to ensure correct spacing between a plurality of straps. For example, as depicted in FIGS. 4A-4B, in some embodiments, a system including a plurality of support straps 300a, 300b may further include a connector strap 370 that, when connected, spans a distance D1 between the support straps 300a, 300b. Accordingly, each support strap (e.g., a first support strap 300a and a second support strap 300b) may be connectable to the connector strap 370 such that the connector strap 370 is connected to and extends between the first support strap 300a and the second support strap 300b when connected (e.g., as depicted in FIG. 4B). Accordingly, each of the support straps 300a, 300b may include a body (e.g., a first body 302a of the first support strap 300a and a second body 302b of the second support strap 300b) with one or more connection points 376 thereon, as particularly shown in FIG. 4A. The connection points 376 may generally be any component, structure, or apparatus that provides a location at which the connector strap 370 can attach, such as via one or more corresponding attachment points 374 located on a body 372 of the connector strap 370. Illustrative components that can be used for the one or more connection points 376 and the corresponding attachment points 374 include, but are not limited to, hook and loop connectors, ring connectors, snap connectors, clips, anchors, and/or the like. The location of the connection points 376 on the respective bodies 302a, 302b of the support straps 300a, 300b and the corresponding attachment points 374 on the connector strap 370 are not limited by the present disclosure, and may generally be any location.

Referring again to FIGS. 4A-4B, in some embodiments, the connector strap 370 may be shaped, sized, and configured to ensure a particular spacing of the support straps 300a, 300b when the connector strap 370 is coupled to the support straps 300a, 300b. As such, the body 372 of the connector strap may have a particular shape or size to ensure an appropriate connection. For example a distance D2 of one dimension of the body 372 of the connector strap 370 may be greater than the distance D1 between the support straps 300a, 300b to ensure overlap of the respective bodies 302a, 302b, 372 so a connection can be made via the respective connection points 376 and corresponding attachment points 374. In some embodiments, the body 372 may be formed in various sizes (e.g., small, medium, large, extra-large, or the like) so that a particular size can be selected for a particular subject. Each of such sizes may be made to correspond to one or more average dimensions of a subject having a particular size, for example.

The various components that are used for rotating a subject should now be generally understood. Turning to the remaining figures, FIG. 5 shows a flow diagram of an illustrative method of preparing the various components described herein for rotating a subject, while FIGS. 6 and 7A-7B schematically depict various steps of the method.

The various processes described with respect to FIG. 5 are generally completed by one or more caregivers, such as, for example, the first individual 100a and the second individual 100b depicted in FIG. 1. The description with respect to FIG. 5 generally relates to two caregivers, but it should be understood that fewer or greater caregivers may also complete the various processes described with respect to FIG. 5 without departing from the scope of the present disclosure. Further, while FIGS. 6 and 7A-7B depict the subject 102 being prepared for rotation from a supine position to a prone position, the subject may also be prepared for rotation from a prone position to a supine position using the same processes described with respect to FIG. 5.

Referring to FIGS. 1 and 5, a determination may be made at block 502 as to which side of the support surface 116 the subject 102 will be turned toward. As will be evident from the description that follows, the side of the support surface 116 to which the subject 102 will be turned (e.g., the left side of the support surface 116 or the right side of the support surface 116) dictates the positioning of the support straps 300, as well as which loops to connect to the sling bar 210. Still referring to FIGS. 1 and 5, it may further be necessary to ensure that the subject 102 and/or others (e.g., family members, caregivers, students, etc.) understand the process of rotating the subject. As such, the procedure may be explained to the subject and others at block 504.

In order to ensure a stable surface before rotating the subject 102, it may be necessary to determine if the wheels or casters 118 are unlocked at block 506. If the wheels or casters 118 are unlocked, the method proceeds to block 508, where the casters are locked. Otherwise, the method proceeds to block 510.

At block 510, the height of the support surface 116 may be adjusted. That is, the foot pedal or other control is actuated, thereby causing the plurality of lift members 114 to raise or lower the support surface 116 to a height that allows the first individual 100a and/or the second individual 100b to rotate the subject 102 as described herein. In some embodiments, the height of the support surface 116 may be adjusted to a height that represents a best ergonomic advantage for the first individual 100a and/or the second individual 100b, which may be about elbow height for the first individual 100a and/or the second individual 100b.

Since it may be advantageous to lower the side rails 120 of the person support apparatus 110 to allow better access to the subject 102 by the first individual 100a and/or the second individual 102b, at block 512, a determination may be made as to whether the side rails 120 are raised. Such a determination at block 512 may include determining whether the head rails and/or the intermediate side rails are raised. If the side rails 120 are raised, the process proceeds to block 514 where the side rails 120 are lowered. Once the side rails 120 are lowered, the process proceeds to block 516.

Some subjects that are being rotated may be attached to medical equipment, such as, for example, tubing, leads, lines, braces, and/or the like. For example, a subject in need of breathing assistance may have a tracheostomy tube inserted in his or her airway, the tracheostomy tube fluidly coupled to a ventilator that provides pressurized air (e.g., oxygen). In another example, a subject being monitored for heart and/or brain activity may have a plurality of leads attached to his or her skin. Subjects incapable of eating or drinking may have a central venous catheter fluidly coupled via tubing to an IV fluid source. Such subjects must be carefully rotated to ensure the tubing, leads, lines, braces, and/or the like do not become dislodged, kinked, disconnected, cause injury, and/or the like. Further, care must be taken to ensure the tubing, leads, lines, braces, and/or the like do not hinder rotation of the subject. As such, a determination may be made at block 516 as to whether such tubing, leads, lines, braces, and/or the like is connected to the subject 102 and/or must remain connected to the subject 102 during the rotation process. If tubing, leads, lines, braces, and/or the like are connected to the subject, the process moves to block 518. Otherwise, the process moves to block 520.

At block 518, the various tubing, leads, lines, braces, and/or the like are adjusted. In some embodiments, the tubing, leads, lines, braces, and/or the like may be adjusted by temporarily removing the tubing, leads, lines, braces, and/or the like for the duration of the rotation process. In some embodiments, particularly embodiments where the tubing, leads, lines, braces, and/or the like cannot or should not be removed, the tubing, leads, lines, braces, and/or the like may be moved to a position where they will not hinder rotation of the subject and/or to a position where they will not or are less likely to become dislodged, kinked, disconnected, cause injury, and/or the like. In some embodiments, movement according to block 518 may be to the side of the person support apparatus 110 toward which the subject 102 will be turned, as determined at block 502 (e.g., the “turn toward” side). For example, if it is determined that the subject 102 will be turned toward the left hand side of the person support apparatus 110, the tubing, leads, lines, braces, and/or the like (as well as any equipment attached thereto) may be moved to the left hand side of the person support apparatus 110. In another example, if it is determined that the subject 102 will be turned toward the right hand side of the person support apparatus 110, the tubing, leads, lines, braces, and/or the like (as well as any equipment attached thereto) may be moved to the right hand side of the person support apparatus 110. It should be understood that block 518 is optional, particularly for some longer tubing, leads, lines, braces, and/or the like where it may not be necessary to move them.

Referring now to FIGS. 1, 5, and 6, the plurality of support straps 300 may be positioned underneath the subject 102 at block 520. That is, the plurality of support straps 300 may be positioned between the subject 102 and the person support apparatus 110. In some embodiments, the plurality of support straps 300 may be pre-placed on the person support apparatus 110 prior to the subject 102 being placed on the person support apparatus 110. In such embodiments, the subject 102 and/or the plurality of support straps 300 may be adjusted for positioning at block 520, as described herein. It should be understood that the subject 102 may further be positioned with respect to the plurality of support straps 300 based on the various features of the support straps 300 discussed herein with respect to FIGS. 3A-3I. For example, the subject 102 may be aligned with various indicia in some embodiments.

The support straps 300 may be particularly positioned with respect to the subject 102 in order to achieve rotation of the subject 102 according to the present disclosure. In some embodiments, such a positioning may be based on the type of loops coupled to the support straps 300, the relative length of loops coupled to the support straps 300, and/or lengths of the loops to be coupled to the sling bar 210, as described in greater detail herein. As depicted in the embodiment of FIG. 6, a first support strap 300a may be placed such that the first support strap 300a extends laterally across the subject 102 in a location that is superior relative to a second support strap 300b that also extends laterally across the subject 102 (e.g., located in the −y direction of the coordinate axes of FIG. 6). More specifically, the first support strap 300a may be positioned such that the first edge 330a and the second edge 340a of the first support strap 300a extends in a lateral direction and is positioned at a location that is at or inferior to a shoulder of the subject 102, as depicted in the embodiment of FIG. 6. In some embodiments, the first edge 330a and/or the second edge 340a of the first support strap 300a may be positioned longitudinally between a shoulder and an armpit of the subject 102. In particular embodiments, the first edge 330a of the first support strap 300a may be positioned longitudinally such that the first edge 330a is a third length L3 that is about 1 cm to about 15 cm from the top of a shoulder of the subject 102, including about 1 cm from the top of the shoulder, about 2 cm from the top of the shoulder, about 3 cm from the top of the shoulder, about 4 cm from the top of the shoulder, about 5 cm from the top of the shoulder, about 6 cm from the top of the shoulder, about 7 cm from the top of the shoulder, about 8 cm from the top of the shoulder, about 9 cm from the top of the shoulder, about 10 cm from the top of the shoulder, about 11 cm from the top of the shoulder, about 12 cm from the top of the shoulder, about 13 cm from the top of the shoulder, about 14 cm from the top of the shoulder, about 15 cm from the top of the shoulder, or any value or range between any two of these values (including endpoints). The second support strap 300b may be positioned such that the first edge 330b of the second support strap 300b extends in a lateral direction (e.g., parallel to the first support strap 300a) and is longitudinally positioned at a location that is at or near a greater trochanter of the subject 102, as depicted in the embodiment of FIG. 6. In some embodiments, the second support strap 300b may be positioned such that the first edge 330b of the second support strap 300b and the second edge 340b of the second support strap 300b are longitudinally located between a waist of the subject 102 and a knee of the subject 102.

Referring to FIG. 6, the first support strap 300a may further be positioned such that the first end 310a thereof is located a first length L₁ from a widest lateral part of the subject 102 (e.g., an arm of the subject 102, a shoulder of the subject 102, a torso of the subject 102, or the like) in the area where the first support strap 300a is located with respect to the subject 102. The first support strap 300a may also be positioned such that the second end 320a thereof is located a second length L₂ from the widest lateral part of the subject 102 (e.g., an arm of the subject 102, a shoulder of the subject 102, a torso of the subject 102, or the like) in the area where the first support strap 300a is located. The first length L₁ and the second length L₂ may be such that the subject 102 is to be turned toward a right of the person support apparatus 110 (FIG. 1) and the support straps 300a, 300b (e.g., in the −x direction of the coordinate axes of FIG. 6), the second length L₂ may be shorter than the first length L₁. That is, the subject 102 is positioned such that he or she is centered with the body 302a of the first support strap 300a and the body 302b of the second support strap 300b such that a midline 602 of the subject is aligned with a centerline of the support straps 300a, 300b but off-center when accounting for the loops that are connected (e.g., the first long loop 314a and the second short loop 322b) such that a greater distance exists between the first end 310a of the first support strap 300a (when accounting for loop length) and first end 310b of the second support strap 300b (when accounting for loop length) towards which the subject 102 is to be turned. The first length L₁ and second length L₂ are generally not limited by the present disclosure, and may each be any length.

Still referring to FIG. 6, the second support strap 300b may generally be laterally aligned with the first support strap 300a. That is, the first end 310b of the second support strap 300b may generally be laterally aligned with the first end 310a of the first support strap 300a and the second end 320b of the second support strap 300b may generally be laterally aligned with the second end 320a of the first support strap 300a in embodiments where the second support strap 300b has the same dimensions as the first support strap 300a.

Referring again to FIGS. 1 and 5, once the support straps 300a, 300b have been positioned with respect to the subject 102, the sling bar 210 may be lowered at block 522. The sling bar 210 may generally be lowered to a height above the support surface 116 that is sufficient to connect the loops of the support straps 300a, 300b (FIG. 6). Such a height may be referred to as a “connection height.” In the embodiment depicted in FIG. 2A, the sling bar 210 may be lowered by a user by actuating one or more user interface controls 216 on the hand control unit 212. In the embodiment depicted in FIG. 2B, the sling bar 288 may be lowered by a user by actuating one or more user interface controls 256 on the hand control unit 252. In some embodiments, the sling bar 288 may be manually lowered. In embodiments where a plurality of sling bars are used, each of the plurality of sling bars may be lowered.

Referring to FIGS. 1, 5, and 7A-7B, the sling bar 210 is positioned at block 524. That is, the sling bar 210 is arranged with respect to the support surface 116 of the person support apparatus 110 and the support straps 300a, 300b (FIG. 7A). As shown in FIG. 7A, the sling bar 210 is lowered (e.g., the lifting strap 208 is paid out) and arranged such that the length L (FIG. 2A) of the sling bar 210 is substantially parallel to a sagittal plane of the subject 102. That is, the sling bar 210 is aligned in a lateral direction. Such a positioning of the sling bar 210 may be completed so that the various loops can be connected to the sling bar, as described herein. It should be understood that such an alignment is merely illustrative, and other arrangements and positioning of the sling bar 210 are contemplated. For example, in embodiments where a plurality of sling bars 210a, 210b are used (e.g., the embodiment of FIG. 7B), each of the sling bars 210a, 210b may be arranged at block 524 such that the length L (FIG. 2A) of the sling bar 210 is substantially parallel to a transverse plane of the subject 102 (e.g., transverse to the sagittal plane of the subject). That is, the sling bar 210 is arranged in a longitudinal direction.

Referring to FIGS. 1, 3A, 5, and 7A, various ones of the loops 312, 314, 322, 324 of the support straps 300a, 300b are coupled to the sling bar 210 at block 526. That is, one or more loops 312, 314, 322, 324 are placed such that the loops are held by the first retention component 222 or the second retention component 232 of the sling bar 210.

Placement of the loops 312, 314, 322, 324 according to block 526 may be completed in a particular manner based on how the subject 102 is arranged on the support straps 300a, 300b, the various features of a particular support strap 300, and the direction of rotation. In embodiments utilizing the plurality of support straps 300a, 300b, the long loops 314, 324 may be attached on the side to which the subject 102 is being turned and the short loops 312, 322 may be attached on the opposite side. For example, turning to FIGS. 6 and 7A-7B, in embodiments where the subject 102 is to be turned toward the right side (e.g., turned in the +x direction of the coordinate axes of FIG. 6), the second long loop 324a of the first support strap 300a and the second long loop 324b of the second support strap 300b are attached to the second retention component 232 and the first retention component 222, respectively, because the second long loops 324a, 324b are located on the “turn toward” side (e.g., the right side) as shown in FIG. 6. Accordingly, the first short loop 312a of the first support strap 300a and the first short loop 312b of the second support strap 300b (hidden from view in FIG. 7A) are attached to the second retention component 232 and the first retention component 222, respectively, because the first long loops 314a, 314b are not located on the “turn toward” side (e.g., the left side) as shown in FIG. 6. Such a connection of the loops as described above is necessary to ensure the appropriate “offset” needed for rotating the subject 102.

While not depicted in the figures herein, in embodiments where the subject 102 is to be turned toward the left side (e.g., in the −x direction of the coordinate axes of FIG. 6), the first long loop 314a of the first support strap 300a and the first long loop 314b of the second support strap 300b (hidden from view in FIG. 7A) are attached to the second retention component 232 and the first retention component 222, respectively, and the second short loop 322a of the first support strap 300a and the second short loop 322b of the second support strap 300b are attached to the second retention component 232 and the first retention component 222, respectively.

In the embodiment depicted in FIG. 7A, only one lift (not shown) and one sling bar 210 are depicted over the support surface 116 of the person support apparatus 110. That is, a single lift is used to facilitate rotation the subject 102. However, as previously discussed herein, a plurality of lifts may be used to facilitate rotation of the subject 102 in some embodiments. For example, FIG. 7B depicts use of two lifts, each having a respective sling bar 210a, 210b, that work in tandem to raise and lower over the support surface 116 of the person support apparatus 110 when actuated to facilitate rotation of the subject 102. That is, as shown in FIG. 7B, a first sling bar 210a may have a first retention component 222a thereof holding the second long loop 324a and a second retention component (hidden from view) thereof holding the first short loop (hidden from view) of the first support strap 300a. A second sling bar 210b may have a first retention component 222b thereof holding the second long loop 324b and a second retention component (hidden from view) thereof holding the first short loop (hidden from view) of the second support strap 300b.

Referring again to FIGS. 1 and 5, the subject 102 is now placed on the support straps 300a, 300b, which is connected to the sling bar 210 in an appropriate manner necessary for rotation. As such, the process proceeds at block 528 to rotate the subject. Such a process generally includes raising and lowering the lift to cause the subject to rotate due to the positioning of the subject with respect to the support straps 300a, 300b. More specifically, due to the offset location of the subject 102 with respect to the support straps 300a, 300b when connected to the sling bar 210 as described herein, raising the sling bar 210 causes the subject 102 to turn toward one side such that one side (e.g., the left side) of the subject 102 is raised while the other side (e.g., the right side) of the subject 102 remains in contact with the person support apparatus 110 (e.g., such that the other side acts as a pivot point). The sling bar 320 is raised until the subject 102 is in a lateral recumbent position (e.g., a side-lying position). At such a point, the subject 102 is repositioned with respect to the person support apparatus 110 (e.g., slid from one side of the person support apparatus 110 to another side thereof to make) to make room for further rotation. The sling bar 210 is then lowered, causing the subject 102 to further rotate in the same direction until the subject 102 is laying on the person support apparatus 110. The process according to block 528 can be used to rotate the subject 102 from a prone position to a supine position, and also to rotate the subject 102 from a supine position to a prone position.

In some embodiments, the support strap 300 (and the various features described herein with respect to FIGS. 3A-3I and 4A-4B) and/or the connector strap 370 (and the various features described herein with respect to FIGS. 4A-4B) may be included in various kits of parts. For example, a particular kit of parts may include at least one support strap 300 (e.g., a first support strap 300a and a second support strap 300b) and one or more instructions for positioning the at least one support strap 300 with respect to the subject and/or with respect to one another, such as instructions that correspond to the various processes described herein with respect to FIG. 5. In some embodiments, the kit may further include the connector strap 370 (FIGS. 4A-4B) and instructions for coupling the connector strap, as described herein. In some embodiments, a particular kit of parts may be a set of detachable loops, such as the loops described herein with respect to FIG. 3C, as well as instructions for coupling the loops to an existing support strap and for positioning the support strap with respect to a subject once the loops are coupled.

It should now be understood that the present disclosure relates to various support straps that are customized for the purposes of rotating a subject from a prone position to a supine position and/or from a supine position to a prone position using one or more overhead lifts. The various support straps described herein include features that aid in positioning a subject with respect to the support strap, aid in determining which loops to connect to a sling bar, aid in holding or moving the support strap with respect to the subject, aid in spacing support straps with respect to one another, and/or the like. Users utilizing the support straps described herein can instantly see how to position the support strap and connect the support strap to an overhead lift so that a rotating process can be completed.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A support strap having features to aid in positioning and rotating a horizontally laying subject on a support surface, the support strap comprising:
a body comprising a first end and a second end, the first end spaced a distance apart from the second end;
at least one first loop extending from the first end of the body;
at least one second loop extending from the second end of the body; and
indicia on one or more of the body, the at least one first loop, and the at least one second loop, the indicia indicating an arrangement of the support strap with respect to the subject such that a centerline of the subject is not aligned with a true line of symmetry of the support strap when the at least one first loop is coupled to a first end of a sling bar and the at least one second loop is coupled to a second end of the sling bar.

2. The support strap of claim 1, wherein:
the at least one first loop comprises a first long loop and a first short loop, the first long loop being longer in overall length than the first short loop; and
the at least one second loop comprises a second long loop and a second short loop, the second long loop being longer in overall length than the second short loop.

3. The support strap of claim 1, wherein the at least one first loop comprises three or more first loops and the at least one second loop comprises three or more second loops.

4. The support strap of claim 1, wherein:
the at least one first loop comprises a first fixed loop and a first detachable loop, the first fixed loop is fixed to the first end of the body and the first detachable loop is removably attached to the first end of the body; and
the at least one second loop comprises a second fixed loop and a second detachable loop, the second fixed loop is fixed to the second end of the body and the second detachable loop is removably attached to the second end of the body.

5. The support strap of claim 1, wherein the indicia comprises one or more of:
an image or outline of one or more anatomical features to aid in alignment with corresponding anatomical features of the subject;
a centerline marker;
one or more edge markers, wherein each one of the one or more edge markers are positioned a distance from the first end or the second end of the support strap, the distance representing a particular length of the support strap necessary to cover the subject while the subject is rotating;
an indicator of an upper edge of the support strap is to be longitudinally positioned at a location that is from 1 cm to 15 cm in an inferior direction from a top of a shoulder of the subject;
an indicator of a lower edge of the support strap is to be longitudinally positioned at a location between a waist and a knee of the subject;
an indicator of a lower edge of the support strap is to be longitudinally positioned at a location that corresponds to a greater trochanter of the subject; and
a color coded indicator that corresponds to a particular one of the of the at least one first loop or a particular one of the at least one second loop to be coupled to the sling bar and a direction of rotation.

6. The support strap of claim 1, wherein:
the at least one first loop comprises a first long loop and a first short loop, the first long loop being longer in overall length than the first short loop, the first long loop having a first color or having stitching of the first color and the first short loop having a second color or having stitching of the second color; and
the at least one second loop comprises a second long loop and a second short loop, the second long loop being longer in overall length than the second short loop, the second long loop having the second color or having stitching of the second color and the second short loop having the first color or having stitching of the first color,
wherein the indicia comprises a first indicator of the first color and a second indicator of the second color, the first indicator indicating that the first long loop and the second short loop are coupled to the sling bar to cause rotation in a first direction, and the second indicator indicating that the first short loop and the second long loop are coupled to the sling bar to cause rotation in a second direction.

7. The support strap of claim 1, further comprising one or more first cut out portions at the first end of the support strap and one or more second cut out portions at the second end of the support strap, the one or more first cut out portions and the one or more second cut out portions reinforced and providing a grasping point for positioning the support strap with respect to the subject.

8. The support strap of claim 1, further comprising a first major surface constructed of or coated with a high-friction material and a second major surface constructed of or coated with a low-friction material, the low-friction material having a coefficient of friction that is lower than a coefficient of friction of the high-friction material, wherein the support strap is arranged such that the first major surface faces the subject and the second major surface faces the support surface.

9. The support strap of claim 1, wherein an edge extending between the first end of the support strap and the second end of the support strap comprises one or more side loops coupled to the edge.

10. The support strap of claim 1, further comprising one or more connection points, each one of the one or more connection points couplable to a detachable connector strap.

11. A system for rotating a horizontally laying subject on a support surface, the system comprising:
a support strap comprising:
a body comprising a first end and a second end, the first end spaced a distance apart from the second end;
at least one first loop extending from the first end of the body;
at least one second loop extending from the second end of the body; and
indicia on one or more of the body, the at least one first loop, and the at least one second loop, the indicia indicating an arrangement of the support strap with respect to the subject such that a centerline of the subject is not aligned with a true line of symmetry of the support strap when the at least one first loop is coupled to a first end of a sling bar and the at least one second loop is coupled to a second end of the sling bar.

12. The system of claim 11, further comprising a second strap.

13. The system of claim 12, wherein the second strap comprises:
a body comprising a first end and a second end, the first end spaced a distance apart from the second end;
at least one first loop extending from the first end of the body;
at least one second loop extending from the second end of the body; and
indicia on one or more of the body, the at least one first loop, and the at least one second loop, the indicia indicating an arrangement of the support strap with respect to the subject such that a centerline of the subject is not aligned with a true line of symmetry of the support strap when the at least one first loop is coupled to a first end of a sling bar and the at least one second loop is coupled to a second end of the sling bar.

14. The system of claim 12, further comprising a connector strap connected to and extending between the support strap and the second strap.

15. The system of claim 14, wherein the connector strap is sized to correspond to one or more physical dimensions of the subject such that the support strap and the second strap are spaced apart from one another and arranged at predetermined locations with respect to the subject.

16. The system of claim 11, further comprising the sling bar.

17. The system of claim 16, further comprising an overhead lift supporting the sling bar.

18. A kit of parts, comprising:
a support strap comprising:
a body comprising a first end and a second end, the first end spaced a distance apart from the second end,
at least one first loop extending from the first end of the body,
at least one second loop extending from the second end of the body, and
indicia on one or more of the body, the at least one first loop, and the at least one second loop, the indicia indicating an arrangement of the support strap with respect to the subject such that a centerline of the subject is not aligned with a true line of symmetry of the support strap when the at least one first loop is coupled to a first end of a sling bar and the at least one second loop is coupled to a second end of the sling bar; and
one or more instructions for positioning the support strap with respect to the subject.

19. The kit of parts of claim 18, further comprising:
a second support strap; and
one or more instructions for positioning the second support strap with respect to the subject.

20. The kit of parts of claim 19, further comprising:
a connector strap; and
one or more instructions for positioning the connector strap between the support strap and the second support strap, and for coupling the connector strap to the support strap and the second support strap.
